(19) United States
(12) Patent Application Publication
(10) Pub. No.: US 2016/0061933 A1
(43) Pub. Date: Mar. 3, 2016

(54) METHOD AND APPARATUS FOR MEASURING DISTANCE

(71) Applicant: Samsung Electronics Co., Ltd., Gyeonggi-do (KR)

(72) Inventors: Young-Kwan CHUNG, Seoul (KR); Bu-Seop JUNG, Gyeonggi-do (KR); Ki-Seok KANG, Gyeonggi-do (KR); Ju-Ho KIM, Gyeonggi-do (KR); Yong-Hae CHOI, Gyeonggi-do (KR)

(21) Appl. No.: 14/844,266

(22) Filed: Sep. 3, 2015

(30) Foreign Application Priority Data
Sep. 3, 2014 (KR) 10-2014-0117318

(51) Int. Cl. G01S 5/10; G01S 5/02; H04W 4/02

(52) U.S. Cl. CPC G01S 5/10; H04W 4/023; G01S 5/0226; G01S 5/0252

(57) ABSTRACT

An apparatus is provided comprising: a communication interface; and at least one processor configured to: synchronize the apparatus with at least one electronic device, receive, via the communication interface, a signal from the electronic device, and determine a distance between the apparatus and the electronic device based on a transmission time and a reception time of the signal.

### CLAIM OF PRIORITY

This application claims priority under 35 U.S.C. §119(a) to a Korean Patent Application entitled “METHOD FOR ESTIMATING A DISTANCE AND ELECTRONIC DEVICE THEREOF” filed in the Korean Intellectual Property Office on “Sep. 3, 2014” and assigned Ser. No. “10-2014-0117318”, the contents of which are herein incorporated by reference.

### BACKGROUND

1. Field of the Disclosure

The present disclosure relates to electronic devices and more particularly to a method and apparatus for measuring distance.

2. Description of the Related Art

Recently, with the growth of information telecommunication technologies and semiconductor technologies, various kinds of electronic devices are providing various multimedia services. For one example, various multimedia services based on a distance between electronic devices are being provided. Accordingly, a way for accurately measuring the distance.

The conventional art is suggesting a method using Round Trip Time (RTT) to measure a distance between electronic devices. However, the scheme using the RTT cannot measure a distance with a counterpart electronic device until an electronic device performs a packet transmission/reception process many times, because the electronic device must previously recognize a Medium Access Control (MAC) address of the counterpart electronic device and must transmit/receive a request/response packet with the counterpart electronic device in a unicast scheme.

### SUMMARY

According to aspects of the disclosure, an apparatus is provided comprising: a communication interface; and at least one processor configured to: synchronize the apparatus with at least one electronic device, receive, via the communication interface, a signal from the electronic device, and determine a distance between the apparatus and the electronic device based on a transmission time and a reception time of the signal.

According to aspects of the disclosure, a method is provided comprising synchronizing a apparatus with at least one electronic device, receiving a signal from the electronic device, and determining a distance between the apparatus and the electronic device based on a transmission time and a reception time of the signal.

### BRIEF DESCRIPTION OF THE DRAWINGS

The above and other objects, features and advantages of the present disclosure will become more apparent from the following detailed description when taken in conjunction with the accompanying drawings in which:

FIG. 1 is a flowchart of an example of a process, according to aspects of the disclosure;

FIG. 2A illustrates a cluster consisting of a plurality of electronic devices in a wireless short-range communication system, according to aspects of the disclosure;

FIG. 2B is a diagram illustrating the exchange of beacons and Service Discovery Frames (SDF) in a wireless short-range communication system, according to aspects of the disclosure;

FIG. 3A is a diagram illustrating the exchange of beacons and service discovery frames of electronic devices in a wireless short-range communication system, according to aspects of the disclosure;

FIG. 3B is a diagram illustrating the exchange of beacons and service discovery frames of electronic devices in a wireless short-range communication system, according to aspects of the disclosure;

FIG. 4 is a diagram of an example of the contents of a beacon frame, according to aspects of the disclosure;

FIG. 5 is a sequence diagram illustrating an example of a process for creating and updating a distance table, according to aspects of the disclosure;

FIG. 6A is a diagram of an example of a distance table, according to aspects of the disclosure;

FIG. 6B is a diagram of an example of a distance table, according to aspects of the disclosure;

FIG. 6C is a diagram of an example of a distance table, according to aspects of the disclosure;

FIG. 7 is a diagram providing an example of a hidden node, according to aspects of the disclosure;

FIG. 8A is a diagram of an example of process for constructing a map model based on a distance table, according to aspects of the disclosure;

FIG. 8B is a diagram of an example of process for constructing a map model based on a distance table, according to aspects of the disclosure;

FIG. 8C is a diagram of an example of process for constructing a map model based on a distance table, according to aspects of the disclosure;

FIG. 9 is a diagram of an example of a process for correcting an existing map model, according to aspects of the disclosure;

FIG. 10A is a diagram of an example of a user interface for position correction, according to aspects of the disclosure;

FIG. 10B is a diagram illustrating an example of a process for position correction, according to aspects of the disclosure;

FIG. 11A is a diagram of an example of a user interface for manually specifying the position of an electronic device, according to aspects of the disclosure;

FIG. 11B is a diagram of an example of a user interface for manually specifying the position of an electronic device, according to aspects of the disclosure;

FIG. 12A is a diagram illustrating an example of a process for controlling transmission power, according to aspects of the disclosure;

FIG. 12B is a diagram illustrating an example of a process for providing a service, according to aspects of the disclosure;

FIG. 12C is a diagram illustrating an example of a process for device locking, according to aspects of the disclosure;

FIG. 12D is a diagram illustrating an example of a process for transmitting map-related information to a server, according to aspects of the disclosure;

FIG. 12E is a diagram illustrating an example of a process for transmitting map-related information to other electronic devices, according to aspects of the disclosure;

FIG. 12F is a diagram illustrating an example of a process for sharing information, according to aspects of the disclosure;

FIG. 12G is a diagram illustrating an example of a process for displaying information through other devices, according to aspects of the disclosure;

FIG. 12H is a diagram illustrating an example of a process for displaying information, according to aspects of the disclosure;

FIG. 13 is a flowchart of an example of a process, according to aspects of the disclosure;

FIG. 14 is a flowchart of an example of a process for creating a distance table, according to aspects of the disclosure;

FIG. 15 is a flowchart of an example of process for creating a map model, according to aspects of the disclosure;

FIG. 16 is a diagram of an example of a network environment, according to aspects of the disclosure;

FIG. 17 is a diagram of an example of a position estimation module, according to aspects of the disclosure; and

FIG. 18 is a block diagram of an example of an electronic device, according to aspects of the disclosure.

### DETAILED DESCRIPTION

The following description with reference to the accompanying drawings is provided to assist in a comprehensive understanding of various aspects of the disclosure as defined by the claims and their equivalents. It includes various specific details to assist in that understanding but these are to be regarded as merely exemplary.

Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

As used in the present disclosure, terms such as “includes” or “may include” refer to the presence of the corresponding function, operation or feature, and do not limit the presence of additional functions, operations or features. Also, terms such as “includes” or “has” refers to the presence of characteristics, numbers, steps, operations, components or combinations thereof, and is not intended to exclude one or more additional characteristics, numbers, steps, operations, components or combinations thereof.

As used in the present disclosure, the term “or” is used to include any and all combination of terms listed. For examples, “A or B” includes only A, only B, or both A and B.

As used in the present disclosure, terms such as “first” or “second” may be used to describe various features, but do not limit such features. For example, the terms do not limit the order and/or the importance of their associated features. Such terms may be used to differentiate one feature from another. For example, a first user equipment (alternatively, “UE”) and a second user equipment are both user equipment, but are different user equipment. For example, without departing from the scope of the present disclosure, a first component may be called a second component, and likewise, a second component may be called a first component.

If a component is said to be “connected with” or “connected to” another component, the component may be directly connected with, or connected to, the other component, or another component may exist in between. On the other hand, if a component is said to be “directly connected with” or “directly connected to” another component, it should be understood that no components exist in between.

The terms used in various examples throughout the disclosure are used to just describe specific exemplary embodiments, and do not intend to limit the disclosure. The expression of singular number includes the expression of plural number unless the context clearly dictates otherwise.

Unless defined otherwise, all terms used herein including technological or scientific terms have the same meaning as those commonly understood by a person having ordinary knowledge in the art. Terms as defined in a general dictionary should be interpreted as meanings consistent with the contextual meanings of a related technology, and are not interpreted as ideal or excessively formal meanings unless defined clearly in the disclosure.

An electronic device, according to aspects of the disclosure, can be a device including communication functionality. For example, the electronic device can include at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical appliance, a camera, and a wearable device (e.g., a head-mounted-device (HMD) such as electronic glasses, an electronic textiles, an electronic bracelet, an electronic necklace, an electronic appcessory, an electronic tattoo, and a smart watch).

According to aspects of the disclosure, the electronic device can be a smart home appliance having the communication functionality. The smart home appliance can include, for example, at least one of a television, a Digital Video Disk (DVD) player, an audio, a refrigerator, an air conditioner, a vacuum cleaner, an oven, a microwave oven, a washing machine, an air purifier, a set-top box, a TV box (e.g., Samsung HomeSync™, AppleTV™, or Google TV™), game consoles, an electronic dictionary, a digital key, a camcorder, and a digital frame.

According to aspects of the disclosure, the electronic device can include at least one of various medical appliances (e.g., Magnetic Resonance Angiography (MRA), Magnetic Resonance Imaging (MRI), Computed Tomography (CT), X-ray, ultrasonicator)), a navigation device, a Global Positioning System (GPS) receiver, an Event Data Recorder (EDR), a Flight Data Recorder (FDR), an in-vehicle infotainment device, marine electronic equipment (e.g., marine navigation device and gyro compass), avionics, a security device, an automotive head unit, an industrial or home robot, an Automatic Teller's Machine (ATM) of a financial company, and a Point of Sale (POS) of a store.

According to aspects of the disclosure, the electronic device can include at least one of part of furniture or building/structure having the communication functionality, an electronic board, an electronic signature receiving device, a projector, and various gauges (e.g., gauges for water, electricity, gas, and radio wave). The electronic device according to aspects of the present disclosure can be one or a combination of those various devices. The electronic device can be a flexible device. Also, those skilled in the art shall understand that the electronic device according to aspects of the present disclosure is not limited those devices.

An electronic device according to is described below with reference to the accompanying drawings. The term ‘user’ used in the disclosure may denote a person who uses the electronic device or a device (e.g., an artificial-intelligence electronic device) which uses the electronic device.

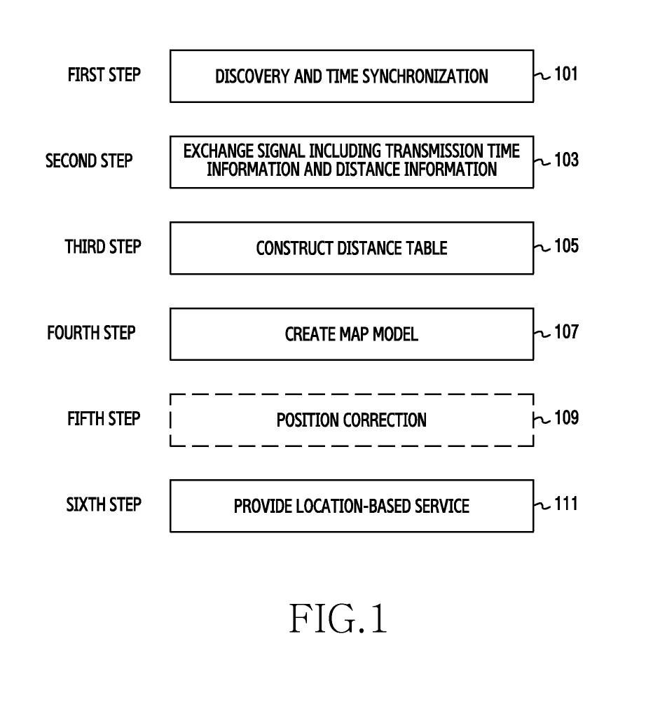

FIG. 1 is a flowchart of an example of a process, according to aspects of the disclosure. The process includes six steps, as follows:

First step (101): An electronic device(e.g., an apparatus) discovers adjacent at least one electronic device, and performs synchronization, for example, time synchronization, with the discovered electronic device.

According to aspects of the disclosure, the electronic device may include any suitable type of device supporting a wireless short-range communication technology (e.g., Wireless Fidelity (WiFi) and Neighbor Awareness Networking (NAN)) may broadcast a discovery signal (e.g., a discovery beacon) for discovering other electronic devices every preset first period (e.g., 100 milliseconds (msec)).

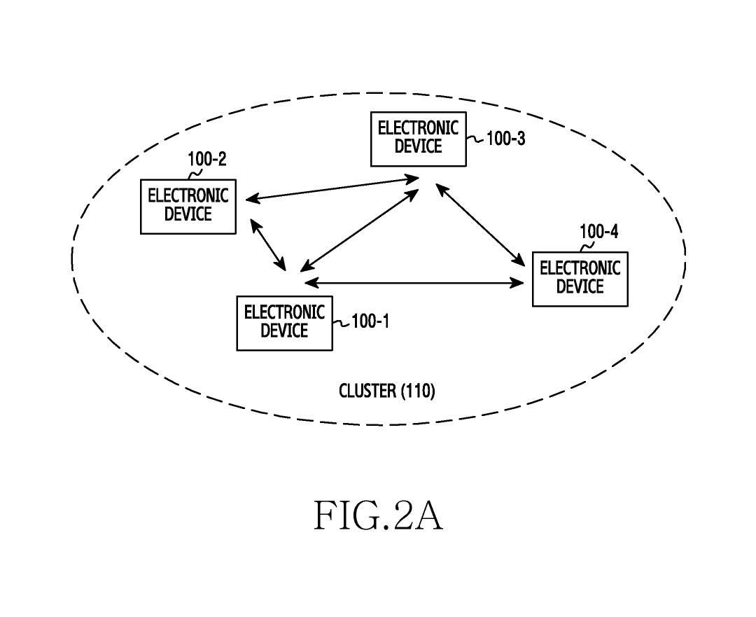

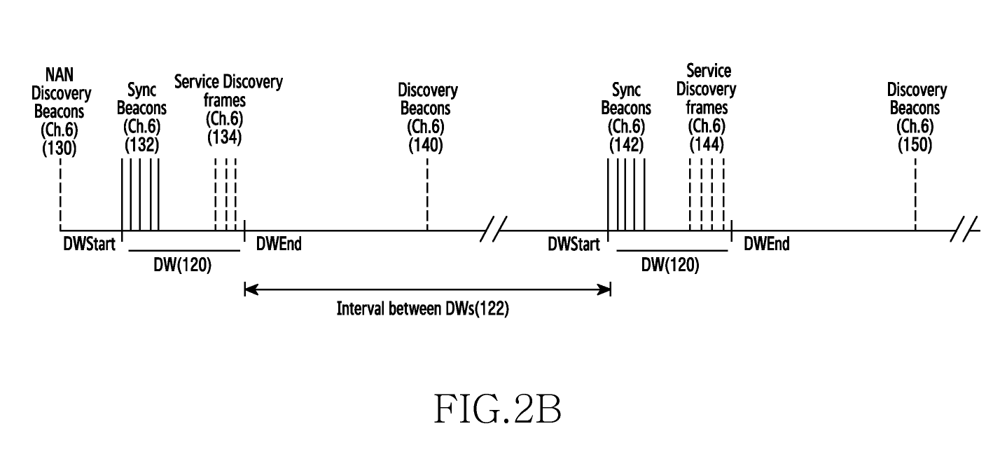

The electronic device may periodically scan a particular frequency (e.g., 10 seconds (sec)) and receive broadcasted discovery signals from other electronic devices. The electronic device recognizes at least one other electronic device located around the electronic device based on the discovery signal received through the scanning, and performs time and channel synchronization with the recognized at least one other electronic device. For example, as illustrated in FIG. 2A, a plurality of electronic devices 100-1 to 100-4 each may transmit a discovery beacon signal to one another and receive a discovery beacon signal from the other electronic devices 100-1 to 100-4. The plurality of electronic devices 100-1 to 100-4 may form one cluster (e.g., a group), and the electronic devices 100-1 to 100-4. Within the cluster, the plurality of electronic devices may perform time and channel synchronization.

The time and channel synchronization may be carried out on a basis of a time and channel of an electronic device having the highest master preference within the cluster. For example, the electronic devices within the cluster formed through discovery may exchange a master preference information signal indicating a preference for operating as an Anchor Master (AM), and may determine as the anchor master the electronic device that has provided the highest master preference. In operation, the anchor master may provide a reference of time and channel synchronization to the electronic devices within the cluster. The anchor master may be changed according to a master preference of the electronic device.

In accordance with aspects of the disclosure, each of the electronic devices having performed the time and channel synchronization may, as illustrated in FIG. 2B, transmit synchronization beacon signals 132 and 142 and Service Discovery Frames (SDFs) 134 and 144 within a Discovery Window (DW) 120 that is repeated according to a preset period. Also, each of the electronic devices having performed the time and channel synchronization may receive synchronization beacon signals 132 and 142 and service discovery frames 134 and 144 from other electronic devices within the cluster. The synchronization beacon signals 132 and 142 may be periodically transmitted/received every discovery window, in order to keep maintaining the time and channel synchronization of the electronic devices within the cluster.

Also, the service discovery frames 134 and 144 may be transmitted/received in the discovery window as necessary in order to provide services to the discovered electronic devices. Also, in accordance with aspects of the disclosure, an electronic device operating as an anchor master among the electronic devices having performed the time and channel synchronization may transmit discovery signals 130, 140, and 150 to sense a new electronic device in an interval 122 between the discovery windows 120.

In accordance with aspects of the disclosure, each of the electronic devices within the cluster operates in an active state only during a discovery window, and operates in a sleep state during an interval other than the discovery windows, thereby being capable of decreasing power consumption. Accordingly, the electronic devices within the cluster may be concurrently activated at the start of the time-synchronized discovery window, and concurrently transitioned into the sleep state at the end of the discovery window.

Second step (103): The electronic device exchanges a signal including transmission time information and distance information with at least one other electronic device having performed the time synchronization.

According to aspects of the disclosure, the electronic device may broadcast a beacon and/or service discovery frame including transmission time information. The transmission time information may indicate a time of broadcasting the beacon and/or service discovery frame on a basis of a synchronized time.

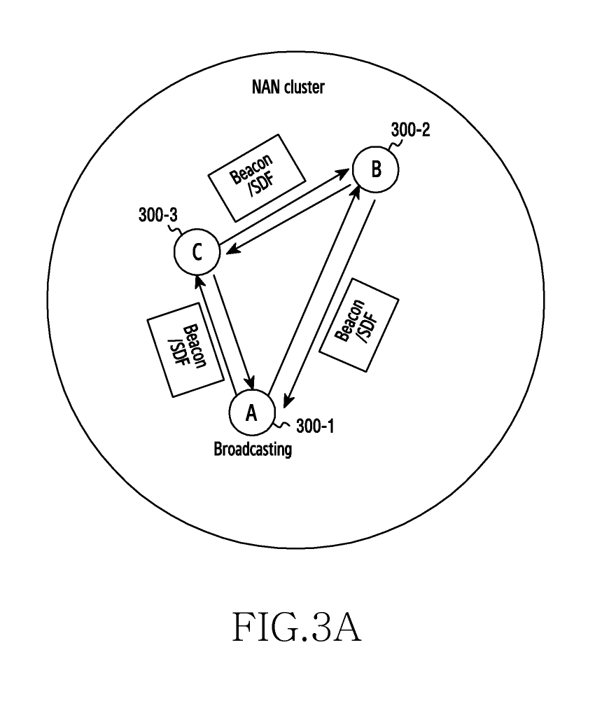

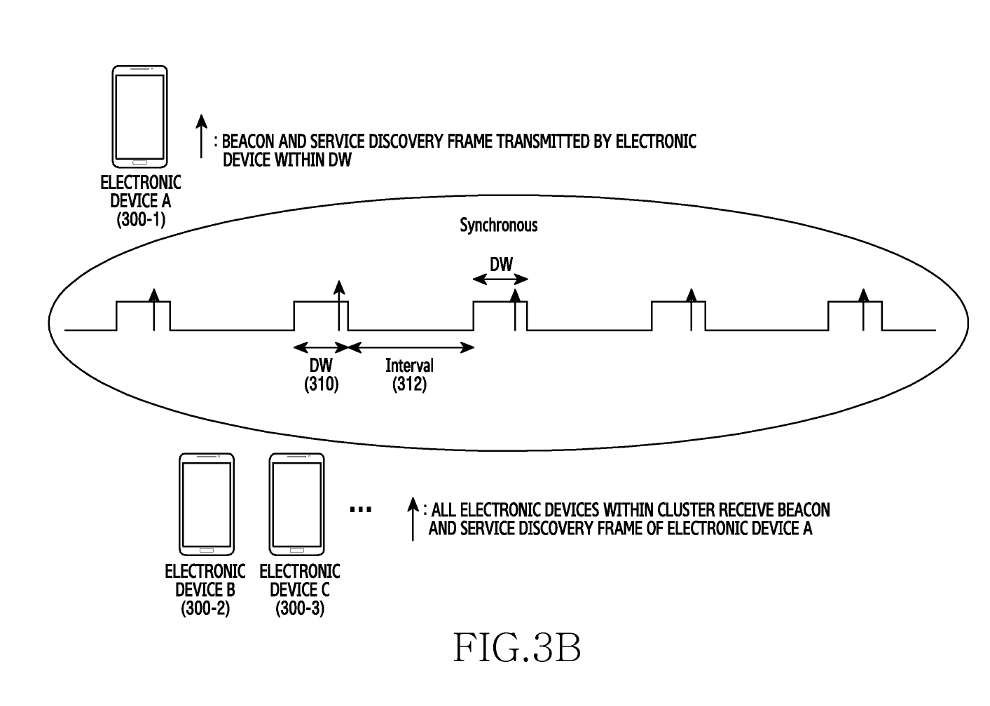

Also, according to aspects of the disclosure, the electronic device may receive beacons and/or service discovery frames including transmission time information from other electronic devices within a cluster. For example, as illustrated in FIG. 3A, in case that electronic devices (A) 300-1, (B) 300-2, and (C) 300-3 form one cluster through a wireless short-range communication technology, each of the electronic devices (A) 300-1, (B) 300-2, and (C) 300-3 may transmit/receive beacons and/or service discovery frames including transmission time information with one another. In detail, as illustrated in FIG. 3B, the electronic device (A) 300-1 may broadcast a beacon and/or service discovery frame including transmission time information every discovery window (DW) 310 that is repeated every preset interval 312, and each of the electronic devices (B) 300-2 and (C) 300-3 receives the beacon and/or service discovery frame broadcasted from the electronic device (A) 300-1 every discovery window (DW) 310.

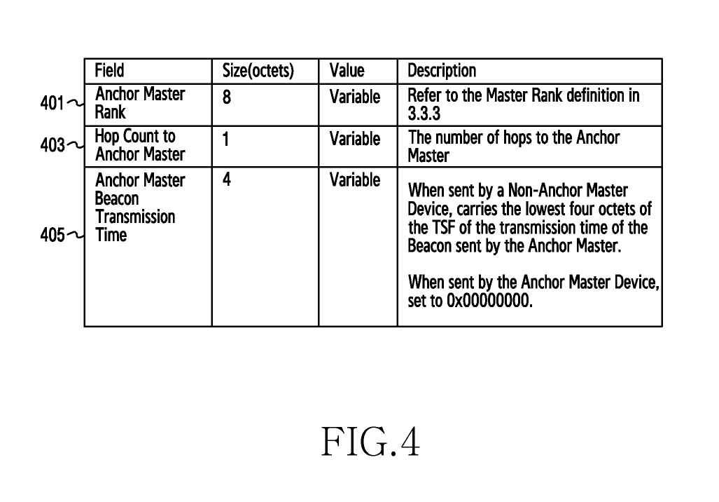

According to aspects of the disclosure, as illustrated in FIG. 4, a beacon and/or service discovery frame broadcasted every discovery window in each electronic device may include an anchor master rank, a hop count to an anchor master, and anchor master beacon transmission time information.

The anchor master rank indicates rank information of an electronic device that is operating as an anchor master within a cluster. If a new electronic device is discovered, the anchor master rank may be used for determining change or non-change of the anchor master. For example, if the new electronic device is discovered, the anchor master rank may determine a master rank of the new electronic device based on a master preference of the new electronic device. The anchor master rank may compare the master rank of the new electronic device with an existing anchor master rank, and determine an electronic device having a higher value as the anchor master.

The hop count to the anchor master represents the number of other electronic devices which are used to forward signals to an electronic device operating as an anchor master in an electronic device transmitting a corresponding beacon and/or service discovery frame. The anchor master beacon transmission time information represents transmission time information that is synchronized on a basis of a time of the anchor master. For example, the anchor master beacon transmission time information signifies information which indicates information about a time transmitting a corresponding beacon and/or service discovery frame, by a time synchronized to a time of the anchor master.

In accordance with aspects of the disclosure, the beacon and/or service discovery frame may include transmission time information corresponding to a resolution desired by an electronic device, instead of the anchor master beacon time information. For example, the beacon and/or service discovery frame may also include transmission time information of the units of nanosecond, picosecond, and microsecond.

In accordance with aspects of the disclosure, the electronic device may control a resolution of the transmission time information, thereby controlling the accuracy of distance estimation between electronic devices described below.

According to aspects of the disclosure, the electronic device may receive beacons and/or service discovery frames including transmission time information from other electronic devices, and measure distances with the other electronic devices. For example, the electronic device may acquire the transmission time information from the beacons and/or service discovery frames received from the other electronic devices, and measure the distances with the other electronic devices based on the acquired transmission time information and time information of reception of the beacons and/or service discovery frames, as in Equation 1 below.

Distance=C*(reception time−transmission time) (Eq. 1)

Herein, the ‘C’ represents the speed of light.

Additionally, according to aspects of the disclosure, an electronic device may include an indication of the distance between the electronic device and at least one other electronic device in a beacon and/or service discovery frame including transmission time information, and broadcast the beacon and/or service discovery frame. For example, the electronic device may receive the beacons and/or service discovery frames from the other electronic devices through a previous discovery window and, in case that distance information about the other electronic devices are previously measured, the electronic device may include the previously measured distance information in the beacons and/or service discovery frames and transmit the beacons and/or service discovery frames.

As another example, the electronic device may include previously measured distance information in any other signals (e.g., other signals within a discovery window, or signals of a general data transmission/reception interval not the discovery window) other than a beacon and/or service discovery frame, and transmit the any other signals. For instance, if a data size of the previously measured distance information is equal to or is greater than a threshold value, the electronic device may include the previously measured distance information in any other signals other than the beacon and/or service discovery frame, and transmit the any other signals. Also, the electronic device may include the previously measured distance information in the any other signals other than the beacon and/or service discovery frame, and transmit the any other signals, regardless of the data size of the previously measured distance information.

In some implementations, the distance information with the other electronic devices may be constructed in a form of a distance table described in third step (105) below.

Also, according to aspects of the disclosure, the electronic device may include its own position in a beacon and/or service discovery frame including transmission time information, and broadcast the beacon and/or service discovery frame. For example, after recognizing its own position coordinate through a Global Positioning System (GPS) or other means, the electronic device may include its own position coordinate in the beacon and/or service discovery frame, and broadcast the beacon and/or service discovery frame.

Also, according to aspects of the disclosure, the electronic device may include its own Multi Input Multi Output (MIMO) related information (e.g., beamforming support or non-support, and transmission/reception beam index information) in a beacon and/or service discovery frame including transmission time information, and broadcast the beacon and/or service discovery frame.

According to aspects of the disclosure, the electronic device may transmit/receive a signal including at least one of transmission time information and distance information with other electronic devices having performed synchronization, through a wireless short-range communication technology (e.g., WiFi and NAN). Also, according to aspects of the disclosure, the electronic device may transmit/receive the signal including at least one of the transmission time information and the distance information with the other electronic devices having performed the synchronization, based on any other communication technologies, for example, communication technologies such as ultrasonic, Bluetooth (BT), Near Field Communication (NFC), and Zigbee, other than the wireless short-range communication technology.

The electronic device may identify a transmission medium based on at least one sensor, and determine a communication technology for transmitting a signal including at least one of transmission time information and distance information, based on the kind of the checked transmission medium. For instance, in case that the electronic device is in water, because a transmission distance of a WiFi signal may be very short and a serious noise may be generated in the WiFi signal, the electronic device may use ultrasonic to exchange transmission time information with other electronic devices having performed synchronization.

The electronic device may store a map associating different transmission media with preferred communications technologies. For example, if the electronic device detects that it is surrounded by “water”, the map may indicate that the communication technology to be used for transmitting/receiving the signal including at least one of the transmission time information and the distance information is “ultrasonic”.

If there is a change of the communication technology used for transmission/reception of a signal including at least one of transmission time information and distance information, the electronic device may start using another equation for measuring distance. For example, if the electronic device uses ultrasonic to receive a signal including at least one of transmission time information and distance information, the electronic device may measure a distance with an electronic device having transmitted the corresponding signal, based on Equation 2 below, not Equation 1 above.

Distance=sound wave speed*(receptiontime−transmission time) (2)

Third step (105): The electronic device may construct a distance table based on time and distance information exchanged with at least one other electronic device.

According to aspects of the disclosure, the electronic device may acquire transmission time information from beacons and/or service discovery frames exchanged with at least one other electronic device in the aforementioned second step (103), and acquire reception time information of each of the beacons and/or service discovery frames. The electronic device may measure a distance with at least one other electronic device based on the information acquired using Equation 1 above, and create a distance table representing a distance between the electronic device and other electronic devices. Also, the electronic device may use the beacons and/or service discovery frames exchanged every discovery window to update the distance table.

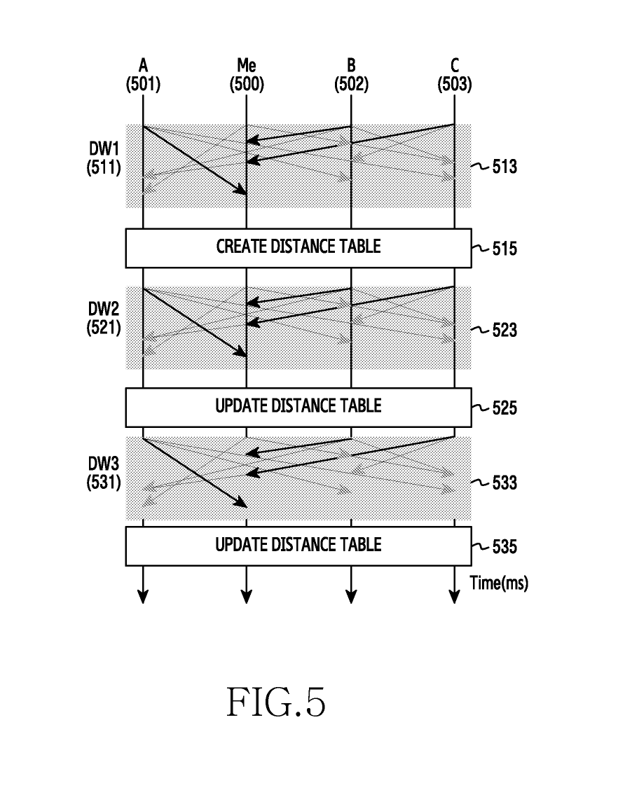

In a more detailed example, as illustrated in FIG. 5, in a first discovery window (DW1) 511, an electronic device (Me) 500 broadcasts a beacon and/or service discovery frame, and receives beacons and/or service discovery frames from electronic devices (A) 501, (B) 502, and (C) 503 having performed time-synchronization (Step 513).

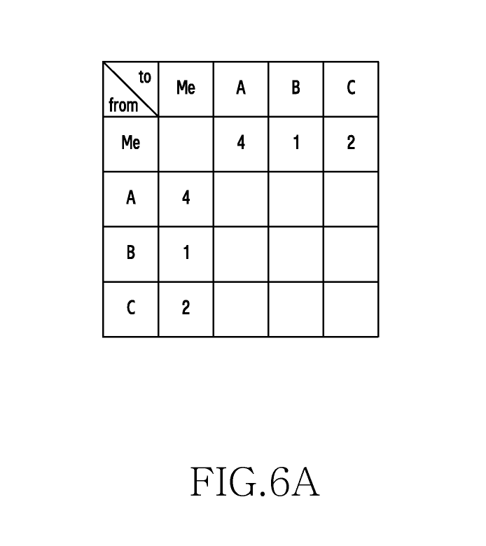

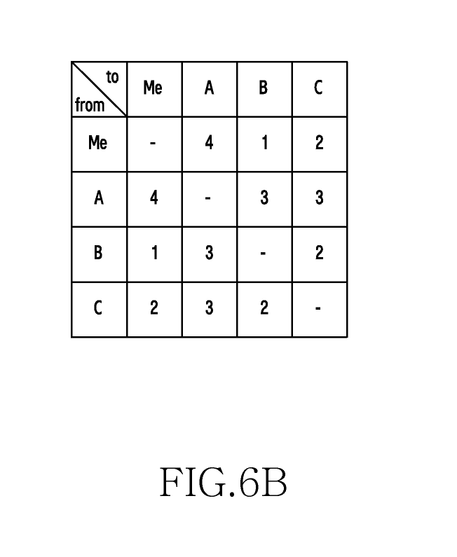

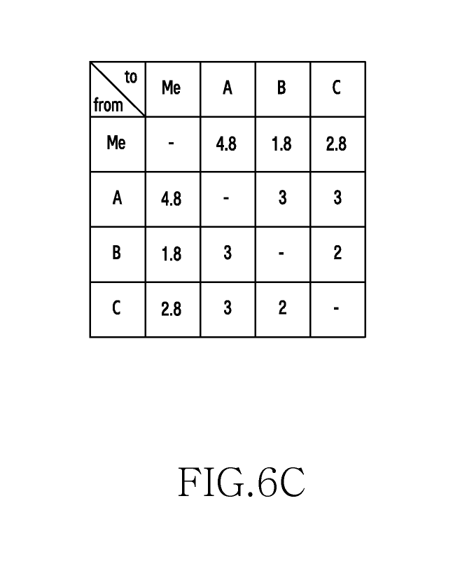

The electronic device (Me) 500 may use the received beacons and/or service discovery frames to measure distances to the electronic devices (A) 501, (B) 502, and (C) 503, and create a distance table based on the measured distances as illustrated in FIG. 6A (Step 515). In accordance with aspects of the disclosure, the beacon and/or service discovery frame may include a MAC address of a corresponding electronic device. For example, the electronic device (Me) 500 may acquire a MAC address from the received beacon and/or service discovery frame and identify whether the corresponding beacon and/or service discovery frame is received from which electronic device among the electronic devices (A) 501, (B) 502, and (C) 503. The electronic device (Me) 500 may measure the distances with the electronic devices (A) 501, (B) 502, and (C) 503 on the basis of the identification result. The distance table illustrated in FIG. 6A represents that a distance between the electronic device (Me) 500 and the electronic device (A) 501 is 4 meter (m), and a distance between the electronic device (Me) 500 and the electronic device (B) 502 is 1 m, and a distance between the electronic device (Me) 500 and the electronic device (C) 503 is 2 m.

After that, in a second discovery window (DW2) 521, the electronic device (Me) 500 broadcasts a beacon and/or service discovery frame, and receives beacons and/or service discovery frames from the electronic devices (A) 501, (B) 502, and (C) 503 having performed time-synchronization (Step 523). For example, the beacons and/or service discovery frames transmitted/received in the second discovery window (DW2) 521 may include distance information with the other electronic devices, since the electronic devices 500 to 503 are in a state of measuring distances with the other electronic devices through the beacons and/or service discovery frames transmitted/received through the first discovery window (DW1) 511.

The electronic device (Me) 500 may use the received beacons and/or service discovery frames to measure distances between the electronic devices (A) 501, (B) 502, and (C) 503, and update the distance table based on the measured distances and the distance information included in the beacons and/or service discovery frames as illustrated in FIG. 6B (Step 525). The distance table illustrated in FIG. 6B represents that a state in which the distances between the electronic device (Me) 500 and the electronic devices (A) 501, (B) 502, and (C) 503 are maintained as 4 m, 1 m, and 2 m as it is, respectively, and represents that the distance between the electronic devices (A) 501 and (B) 502 is equal to 3 m, and the distance between the electronic devices (A) 501 and (C) 503 is equal to 3 m, and the distance between the electronic devices (B) 502 and (C) 503 is equal to 2 m. For example, the distance between the electronic devices (A) 501 and (B) 502, and the distance between the electronic devices (A) 501 and (C) 503, and the distance between the electronic devices (B) 502 and (C) 503 may be acquired from the beacons and/or service discovery frames transmitted/received in the second discovery window (DW2) 521. After that, in a third discovery window (DW3) 531, the electronic device (Me) 500 broadcasts a beacon and/or service discovery frame, and receives beacons and/or service discovery frames from the electronic devices (A) 501, (B) 502, and (C) 503 having performed time-synchronization (Step 533).

The beacons and/or service discovery frames transmitted/received in the third discovery window (DW3) 531 may include distance information associated with other electronic devices. The electronic device (Me) 500 may use the received beacons and/or service discovery frames to measure distances with the electronic devices (A) 501, (B) 502, and (C) 503, and update a distance table based on the measured distances and the distance information included in the beacons and/or service discovery frames as illustrated in FIG. 6C (Step 535). The distance table illustrated in FIG. 6C may show that the distance between the electronic device (Me) 500 and the electronic devices (A) 501, (B) 502, and (C) 503 is changed to 4.8 m, 1.8 m, and 2.8 m, respectively, and show that the distance between the electronic devices (A) 501 and (B) 502, and the distance between the electronic devices (A) 501 and (C) 503, and the distance between the electronic devices (B) 502 and (C) 503 are maintained as 3 m, 3 m, and 2 m, respectively.

In some implementations, the electronic device may update the distance table whenever the discovery window is repeated.

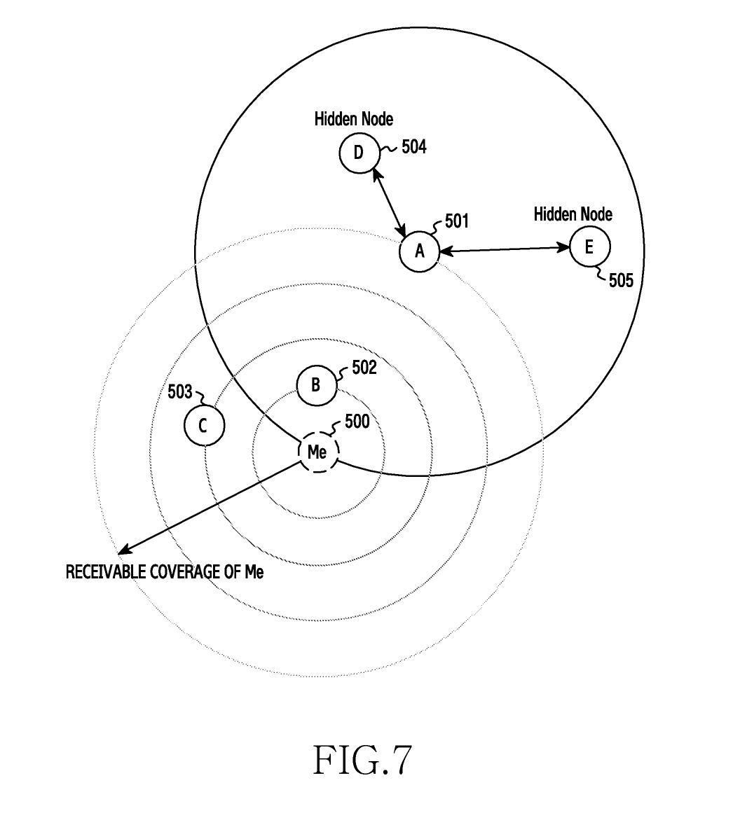

Additionally, the electronic device may receive distance information about a new electronic device not recognized by the electronic device, from a beacon and/or service discovery frame received every discovery window. For example, as illustrated in FIG. 7, the electronic device (Me) 500 may receive discovery signals from the electronic devices (A) 501, (B) 502, and (C) 503, and form a cluster with the electronic devices (A) 501, (B) 502, and (C) 503. However, the electronic device (Me) 500 may not recognize the existence of electronic devices (D) 504 and (E) 505, because the electronic device (Me) 500 may not receive discovery signals from the electronic devices (D) 504 and (E) 505 which are located out of a signal receivable coverage of the electronic device (Me) 500. Accordingly, information of the electronic devices (D) 504 and (E) 505 are not included in the distance table of the electronic device (Me) 500.

However, the electronic device (A) 501 may measure the distance to each of the electronic devices (D) 504 and (E) 505 and may transmit the measured distance information to the electronic device (Me) 500, because the electronic device (A) 501 may receive the discovery signals from the electronic devices (D) 504 and (E) 505. Accordingly, the electronic device (Me) 500 may receive distance information associated with the new electronic devices (D) 504 and (E) 505 of which information does not exist in its own distance table. In this case, the electronic device (Me) 500 may separately store and manage the distance information about the new electronic devices (D) 504 and (E) 505, as hidden nodes, without discarding.

Fourth step (107): The electronic device creates a map model indicating positions of a plurality of electronic devices based on a distance table.

According to aspects of the disclosure, the electronic device may create a map model indicating positions of the electronic device and other electronic devices, based on the distance table acquired through third step (105). For example, the electronic device may use the distance table to create the map model indicating the positions of the other electronic devices on a basis of its own position.

In aspects of the disclosure, the map model may include information and/or graphic element indicating a relative position and distance between electronic devices that is created through modeling on the basis of the distance information between the electronic devices included in the distance table, and/or an absolute position and distance thereof. For instance, the electronic device may set its own position coordinate as (0, 0), and estimate position coordinates of other electronic devices on a basis of the position coordinate (0, 0) of the electronic device.

To estimate positions of other electronic devices, the electronic device may determine at least one reference electronic device among the other electronic devices. In an example, the electronic device may determine, as the reference electronic device, an electronic device whose position is acquired through a beacon and/or service discovery frame, among other electronic devices included in a cluster (for instance, other electronic devices of which information exist in the distance table).

In another example, the electronic device may determine, as the reference electronic device, another electronic device that is the closest to the electronic device from among the other electronic devices in the cluster. In a further example, the electronic device may determine, as the reference electronic device, an electronic device of which position estimation is possible using information (e.g., Multiple Input Multiple Output (MIMO) related information) included in a beacon and/or service discovery frame, among the other electronic devices included in the cluster.

In a yet another example, the electronic device may determine, as the reference electronic device, an electronic device whose position is known. For example, the electronic device may provide an interface of requesting the user to determine as a reference electronic device an electronic device of which position is known by the user (e.g., other electronic devices that the user possesses, or an electronic device of which position is known by the user with user's naked eyes because it is located around the user). The electronic device may receive an input of information (e.g., position information and direction information) about the electronic device whose position is known by the user, from the user through the interface, acquire the position of the corresponding electronic device based on the inputted information, and determine the corresponding electronic device as the reference electronic device.

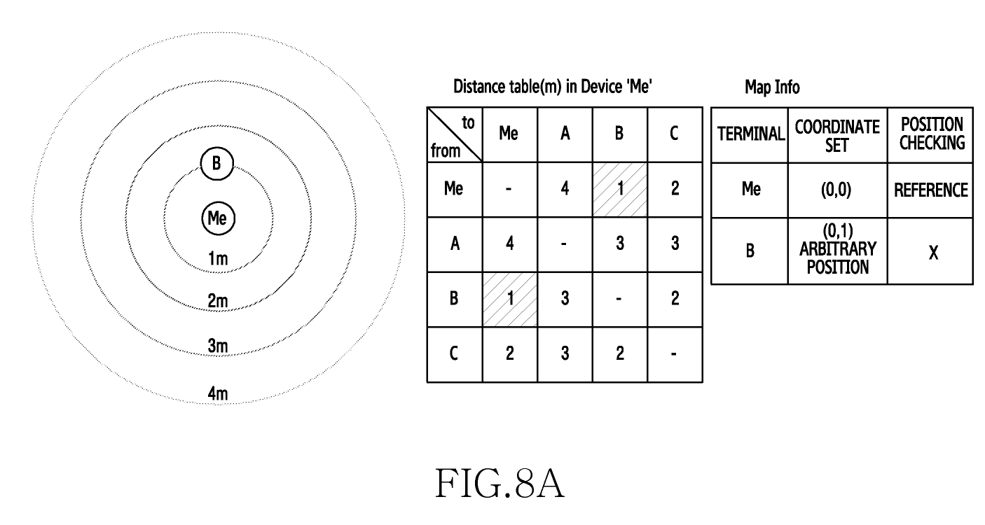

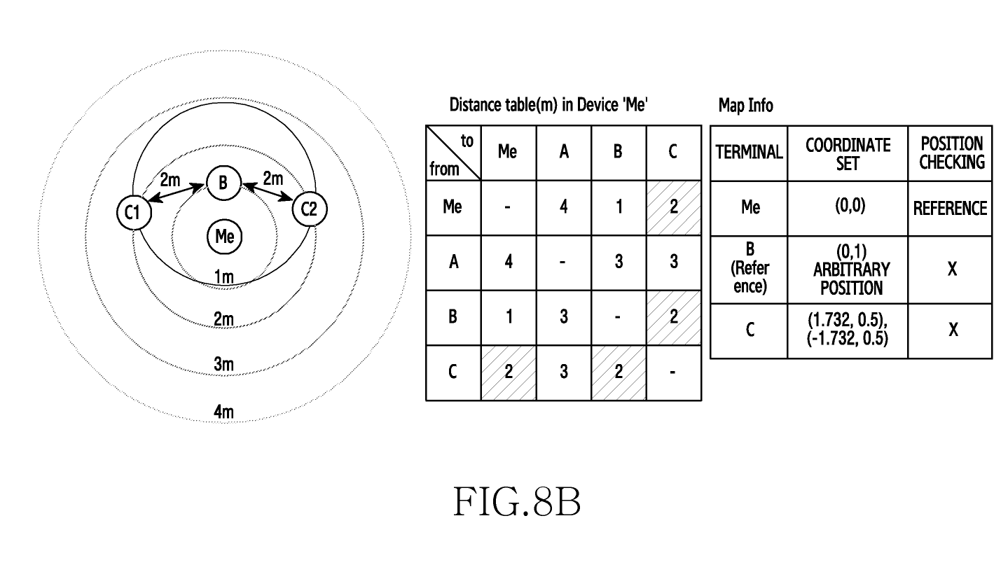

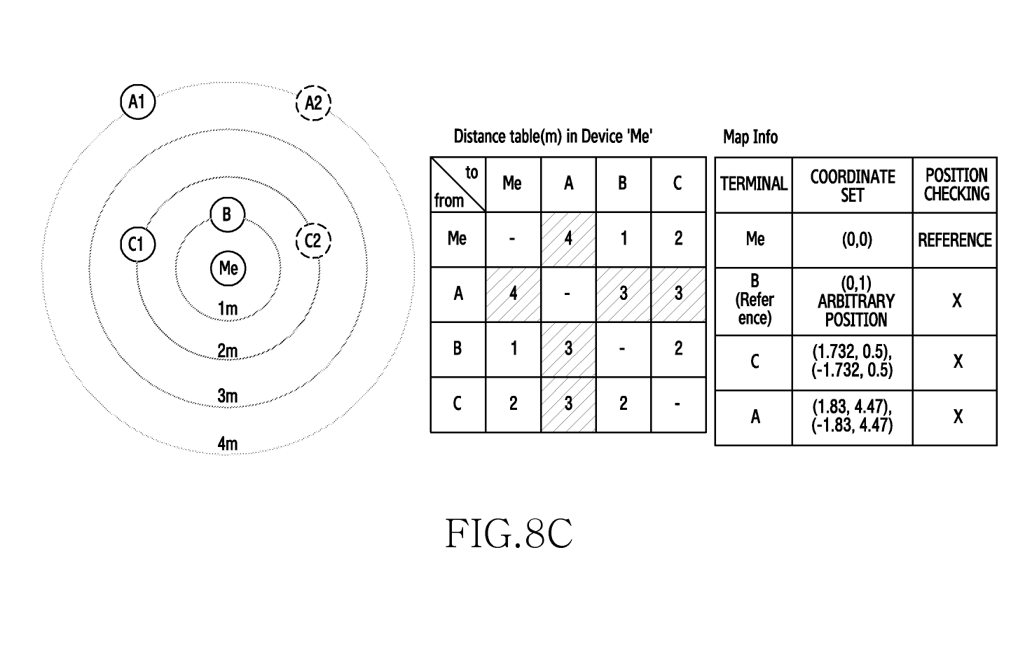

In still another example, the electronic device may arbitrarily select at least one electronic device among other electronic devices included in a cluster as a reference electronic device. The electronic device may determine positions of other electronic devices based on a distance table and positions of the electronic device and the reference electronic device. For example, as illustrated in FIG. 8A, the electronic device may set a coordinate of an electronic device (Me) as (0, 0), and select as a reference electronic device an electronic device (B) having the shortest measured distance from the electronic device (Me) in the distance table. At this time, because a distance between the electronic device (Me) and the electronic device (B) is equal to 1 m, the electronic device may recognize that the electronic device (B) is located in an arbitrary position of a circle whose radius is equal to 1 m and whose central point is a coordinate (0, 0) of the electronic device (Me).

For the sake of position estimation, the electronic device may arbitrarily set a position coordinate of the electronic device (B) as (0, 1). At this time, the electronic device may show map information in which a position coordinate of the electronic device (Me) is (0, 0), and a position coordinate of the electronic device (B) is (0, 1), and an indication of whether the position coordinate (0, 1) of the electronic device (B) has been checked as an accurate position. As illustrated in FIG. 8B, the electronic device may determine a position coordinate of an electronic device (C) having the second short distance with the electronic device (Me), on a basis of position coordinates of the electronic devices (A) and (B). For example, because a distance between the electronic device (Me) and the electronic device (C) is equal to 2 m and a distance between the electronic device (B) and the electronic device (C) is equal to 2 m, two intersecting points (C1 and C2) between a circle whose radius is equal to 2 m and whose central point is the coordinate (0, 0) of the electronic device (Me) and a circle whose radius is equal to 2 m and whose central point is the coordinate (0, 1) of the electronic device (B) may be determined as candidate position coordinates of the electronic device (C). At this time, the electronic device may indicate map information in which the position coordinate of the electronic device (Me) is (0, 0) and the position coordinate of the electronic device (B) is (0, 1). At this time, assuming that the position coordinate of the electronic device (B) is (0, 1), the electronic device may indicate that a position coordinate of the electronic device (C) may be any one of (1.732, 0.5) or (−1.732, 0.5). At this time, the electronic device may indicate that the position coordinates of the electronic devices (B) and (C) have been checked as accurate positions.

Afterwards, as illustrated in FIG. 8C, the electronic device may determine a position coordinate of the electronic device (A) having the longest distance with the electronic device (Me), on a basis of the position coordinates of the electronic devices (A), (B), and (C). For example, because a distance between the electronic device (Me) and the electronic device (A) is equal to 4 m, and a distance between the electronic device (B) and the electronic device (A) is equal to 3 m, and a distance between the electronic device (C) and the electronic device (A) is equal to 3 m, the electronic device may determine as the position coordinate of the electronic device (A) a position coordinate having distances of 4 m, 3 m, and 3 m from the respective position coordinates of the electronic devices (Me), (B), and (C). For example, since the electronic device (C) has two estimated positions (C1 and C2), a position of the electronic device (A) may be estimated as ‘A1’ when using the electronic devices (Me), (B), and (C1) and be estimated as ‘A2’ when using the electronic devices (Me), (B), and (C2). For example, when assuming that the position coordinate of the electronic device (C) is (1.732, 0.5), the position coordinate of the electronic device (A) may be estimated as (1.6, 3.3) and, when assuming that the position coordinate of the electronic device (C) is (−1.732, 0.5), the position coordinate of the electronic device (A) is estimated as (−1.83, 4.47). Next, the electronic device may indicate map information in which the position coordinate of the electronic device (Me) is (0, 0) and the position coordinate of the electronic device (B) is (0, 1) and, when assuming that the position coordinate of the electronic device (B) is (0, 1), the position coordinate of the electronic device (C) is any one of (1.732, 0.5) or (−1.732, 0.5), and the position coordinate of the electronic device (A) is any one of (1.83, 4.47) or (−1.83, 4.47). Next, the electronic device may indicate map information in which the position coordinates of the electronic devices (B), (C), and (A) have been checked as accurate positions. According to FIG. 8A to FIG. 8C, because the position coordinate of the electronic device (B) selected as the reference electronic device is arbitrarily selected, the map information may include information indicating that the position coordinates of the electronic devices (B), (C), and (A) are not accurate positions.

As described above, in aspects of the disclosure, the map information may include information indicating a position coordinate of each electronic device included in a distance table and a coordinate becoming a reference for a relative position, information indicating a reference electronic device, and information indicating whether a position coordinate of each electronic device is accurate.

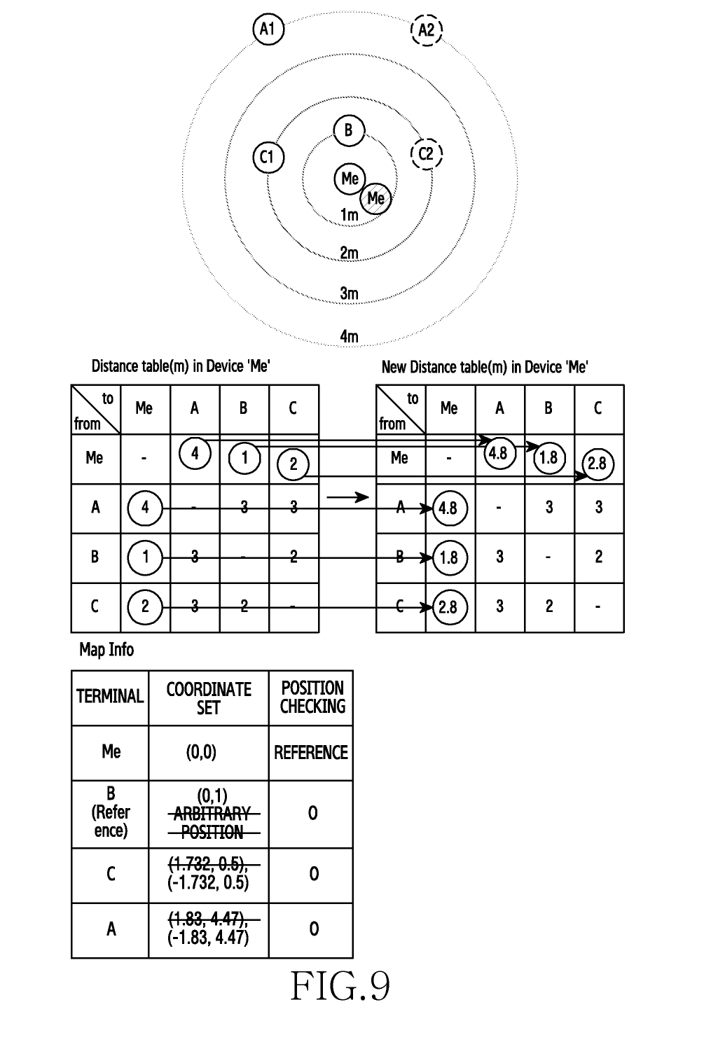

Additionally, in case that a distance table is updated due to movement of an electronic device in accordance with aspects of the disclosure, the electronic device may correct a map model based on a movement direction of the electronic device and the updated distance table. For example, as illustrated in FIG. 9, in case that the electronic device (Me) moves to the right and distances between the electronic device (Me) and the electronic devices (A), (B, and (C) are changed from 4 m, 1 m, 2 m to 4.8 m, 1.8 m, 2.8 m, the electronic device may determine that position coordinates of the respective electronic devices (B), (C), and (A) are (0,1), (−1.732, 0.5), and (−1.83, 4.47).

Fifth step (109): The electronic device may correct a position of at least one electronic device in a map model constructed to indicate positions of a plurality of electronic devices.

According to aspects of the disclosure, in case that a position of at least one electronic device is an inaccurate position in the map model acquired through fourth step (107), the electronic device may correct the inaccurate position of the electronic device. For example, as illustrated in FIG. 8C, in case that the distance table is not updated in a state in which the electronic devices (C) and (A) have two or more estimated positions, the electronic device may sense that position correction is needed.

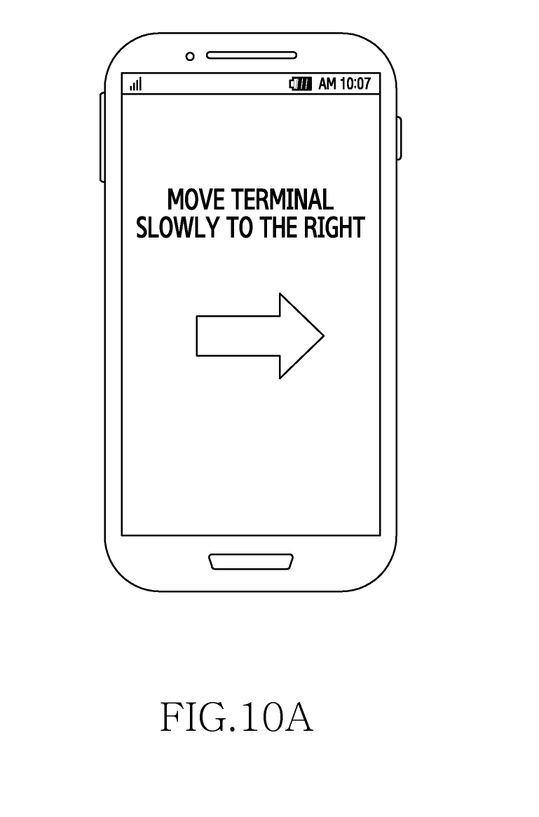

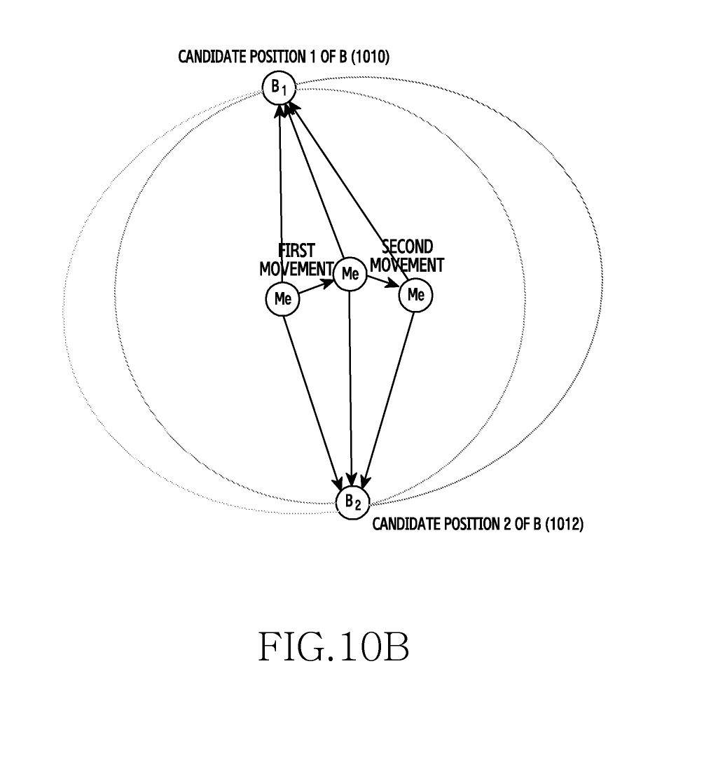

In accordance with aspects of the disclosure, the electronic device may acquire the position of a reference electronic device based on movement of the terminal caused by a user motion and correct positions of electronic devices included in a map model. For example, to correct the positions of the electronic devices included in the map model, as illustrated in FIG. 10A, the electronic device may display on a screen a prompt requesting to use the terminal. In some implementations, as illustrated, the prompt may specify a particular direction of movement.

In case that the movement of the electronic device caused by the user motion is sensed, as illustrated in FIG. 10B, the electronic device may divide the movement of the electronic device into first movement and second movement. The electronic device may determine a candidate position of a reference electronic device (B) among a plurality of electronic devices, based on a movement direction of the first movement, a movement distance, and/or a moved position coordinate. For example, the electronic device may acquire a position coordinate before the movement of the electronic device and a position coordinate after the first movement, and acquire distance information (r1) for the reference electronic device (B) at the position coordinate before the movement and acquire distance information (r2) for the reference electronic device (B) at the position coordinate after the first movement. The electronic device may determine, as the candidate positions of the reference electronic device (B), two intersecting points (B1 and B2) between a circle whose central point is the position coordinate before the movement and whose radius is ‘r1’, and a circle whose central point is the position coordinate after the movement and whose radius is ‘r2’.

After that, the electronic device may check an accurate position of the reference electronic device (B) based on a movement direction of the second movement, a movement distance, and/or a moved position coordinate. For example, as illustrated in FIG. 10B, in case that the movement direction of the second movement is the 5 o'clock direction, and a distance for the reference electronic device (B) is decreased at the position coordinate after the second movement, the electronic device may determine as the accurate position of the reference electronic device (B) a candidate position (B2) 1012 among candidate positions (B1) 1010 and (B2) 1012. Accordingly, the electronic device may correct the position of the reference electronic device (B) in the created map model. Additionally, the electronic device may correct a position of at least one other electronic device in the map model based on the corrected position of the reference electronic device (B).

In accordance with aspects of the disclosure, in case that a user's motion is sensed in a state of not sending a request for movement for position correction to a user, the electronic device may omit an operation of sending the request for the movement for position correction to the user, and acquire the position of a reference electronic device based on movement of the electronic device caused by the sensed user's motion and correct positions of the electronic devices included in the map model.

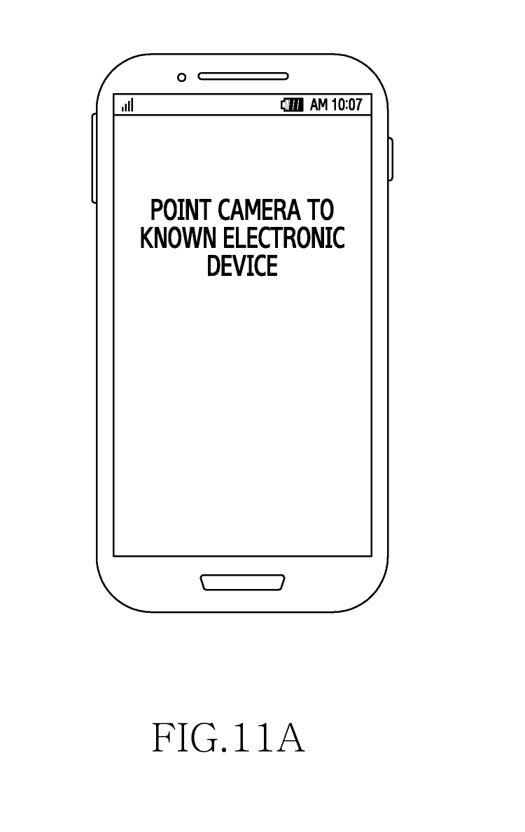

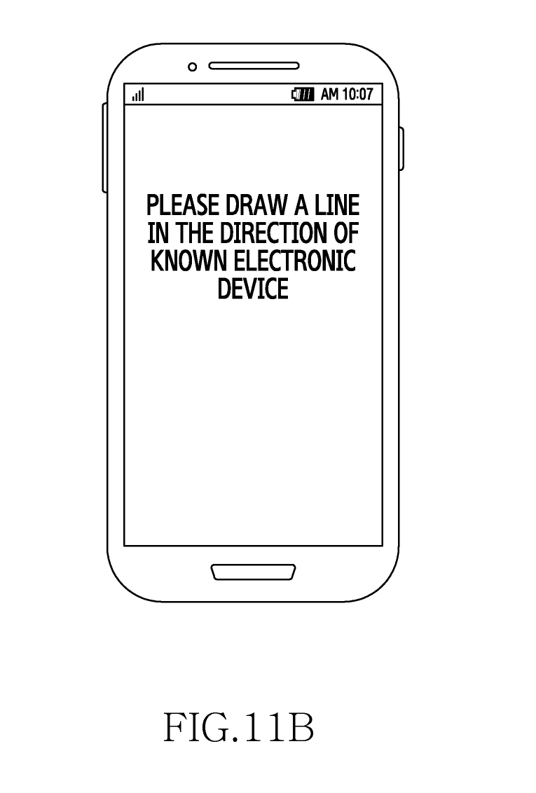

In accordance with aspects of the disclosure, the electronic device may acquire the position of at least one electronic device based on a user input, and correct positions of electronic devices included in a map model. For example, as illustrated in FIG. 11A, the electronic device may request the user to point the camera of the electronic device to another electronic device whose position is known by the user. If the camera of the electronic device faces a specific electronic device, the electronic device may identify the orientation of the electronic device (and/or camera). The electronic device may use the identified orientation to determine the direction in which the specific electronic device is located, and estimate a position of the specific electronic device based on the determined direction and map information stored at the time of map model creation.

In another example, as illustrated in FIG. 11B, the electronic device may request a user to manually input the direction of an electronic device whose position is known by the user. The electronic device may set the direction of a specific electronic device based on direction in which a screen is touched by the user or direction information directly inputted from the user. If the direction in which the specific electronic device is located is determined, the electronic device may estimate a position of the specific electronic device based on the determined direction and the map information stored at the time of map model creation. Additionally, the electronic device may correct a position of at least one other electronic device in a map model based on the estimated position of the specific electronic device.

In some implementations, when there is a specific electronic device whose position is known to a user of the electronic device through any other means other than a beacon and/or service discovery frame among electronic devices within a cluster, the electronic device may use the position of the specific electronic device to correct a position of at least one electronic device included in a map model. Also, the electronic device may use other communication means (e.g., Bluetooth) to send a request for transmission of position information to at least one electronic device among the electronic devices within the cluster, and receive the position information from the corresponding electronic device. The electronic device may use the received position information to correct the position of the at least one electronic device included in the map model. At this time, the electronic device may display a screen for setting other communication means necessary for receiving the position (e.g., a screen requesting the user to turn On a Bluetooth function).

In some implementations, the electronic device may support a beamforming technology, and at least one electronic device among electronic devices within a cluster may support the beamforming technology. In this case, the electronic device may perform beam training with the electronic device supporting the beamforming technology, and identify the direction in which the corresponding electronic device is located on a basis of the electronic device. For example, the electronic device may perform beam training with a specific electronic device within the cluster and determine a transmission/reception beam index of the specific electronic device. The electronic device may check the direction of the specific electronic device, based on the determined transmission/reception beam index and direction information of the electronic device acquirable through a sensor. If the direction in which the specific electronic device is located is determined, the electronic device may estimate a position of the specific electronic device based on the determined direction and map information stored at the time of map model creation. Additionally, the electronic device may correct a position of at least one other electronic device in a map model, based on the estimated position of the specific electronic device.

Sixth step (111): The electronic device may use the created map model to provide a location based service.

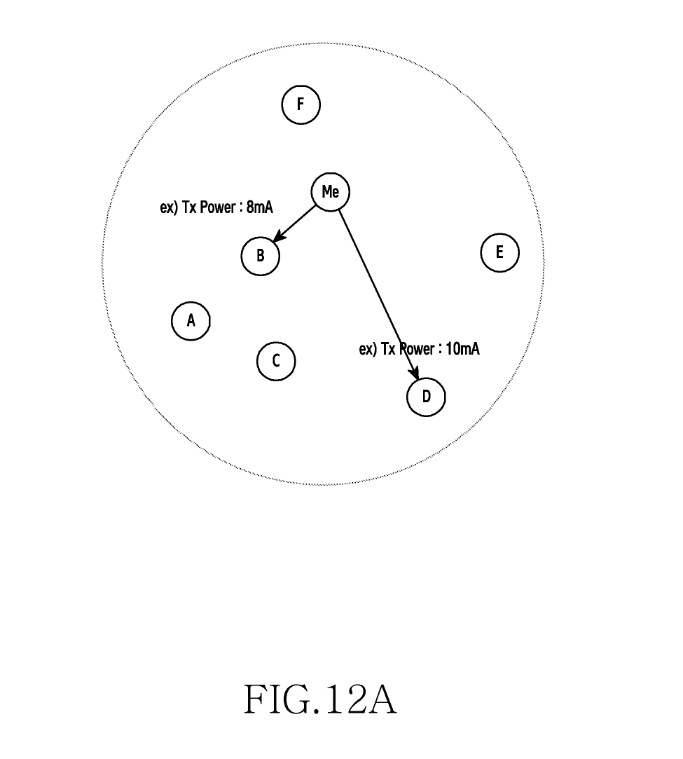

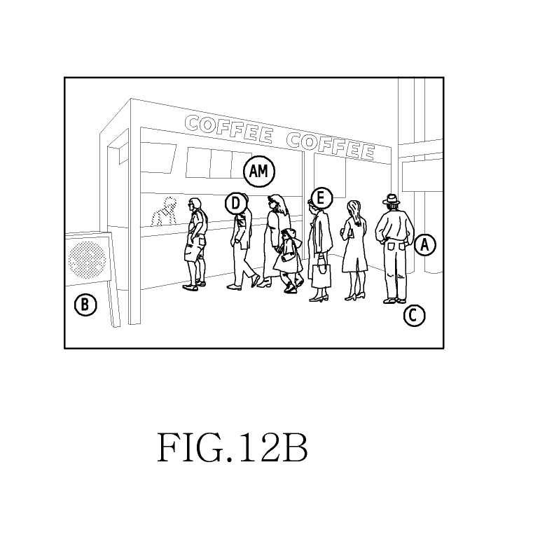

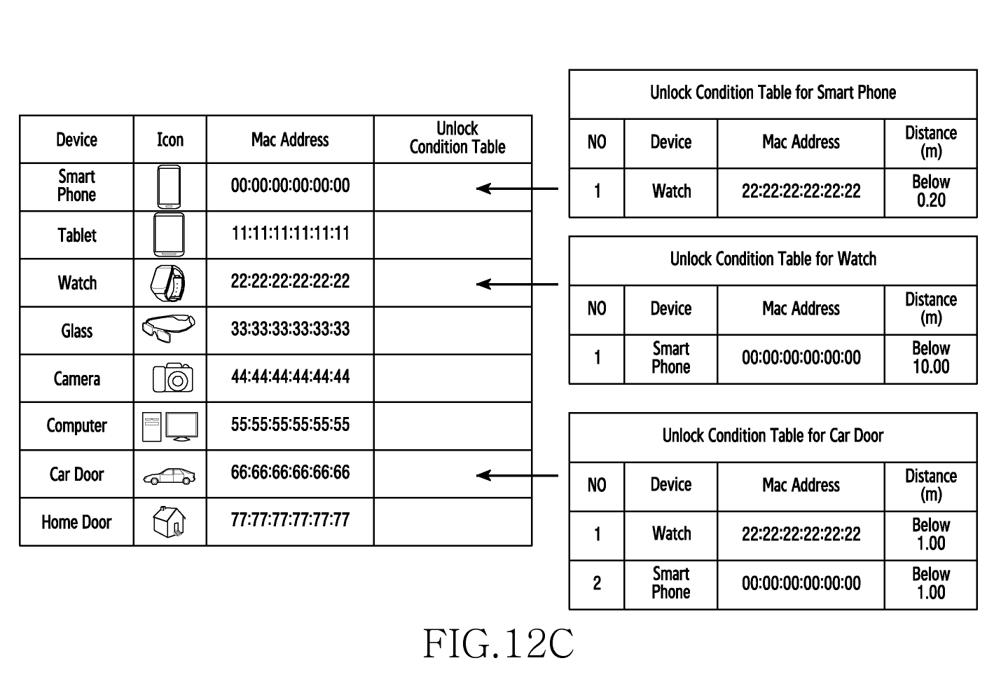

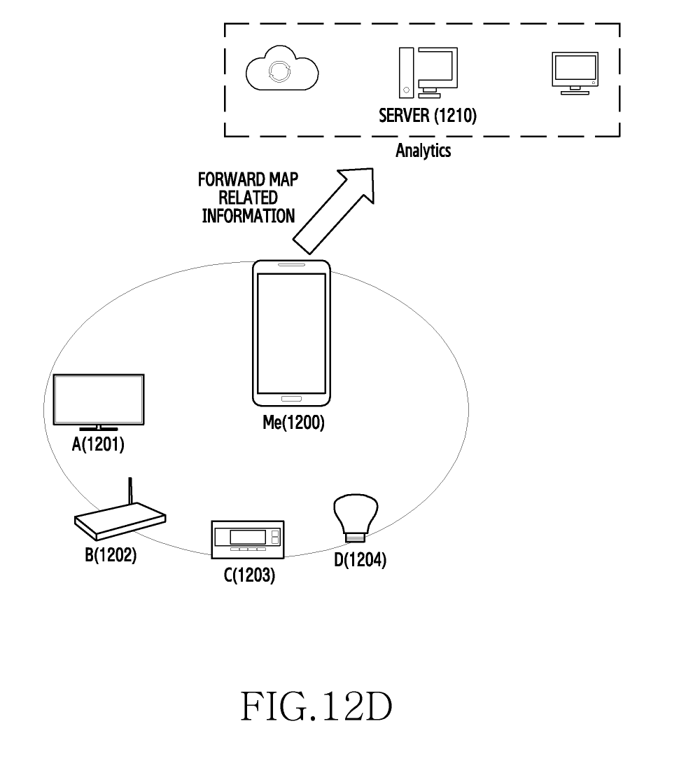

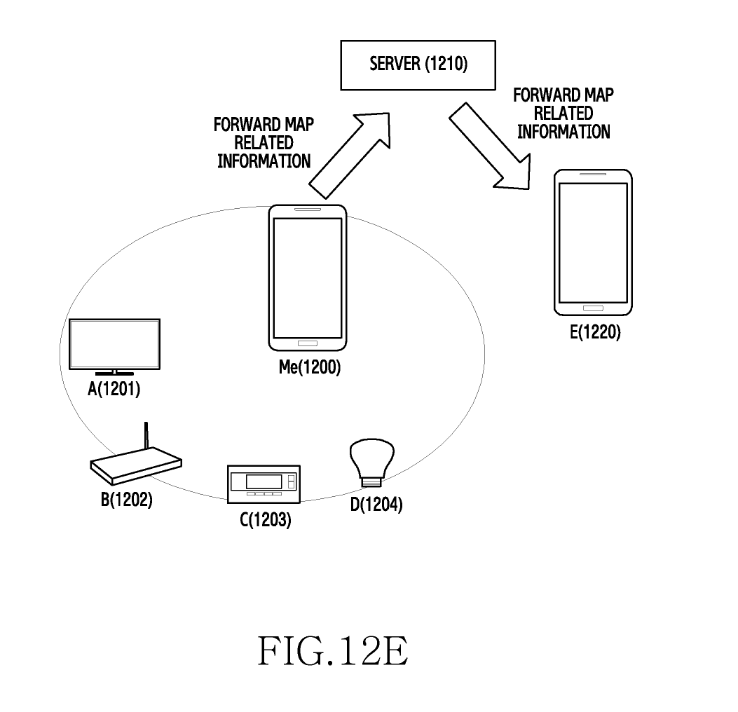

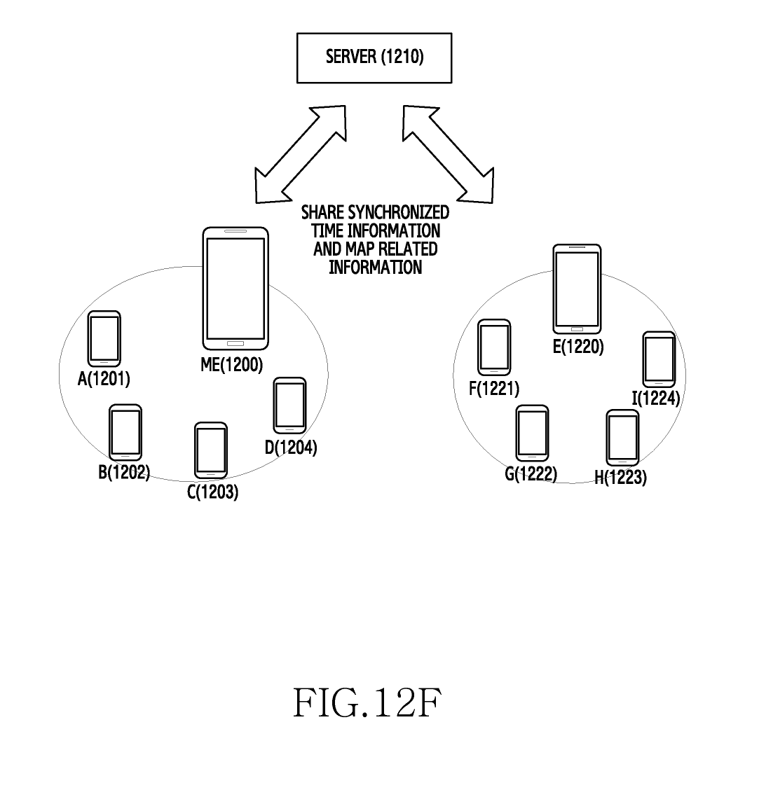

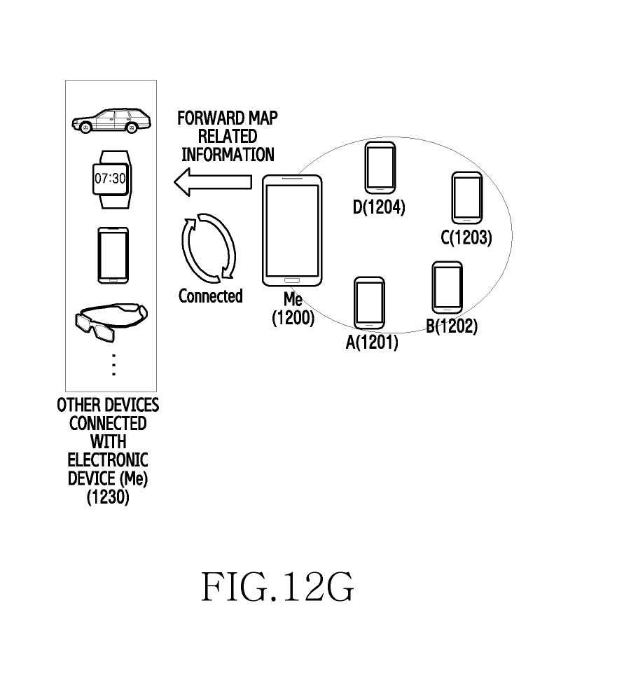

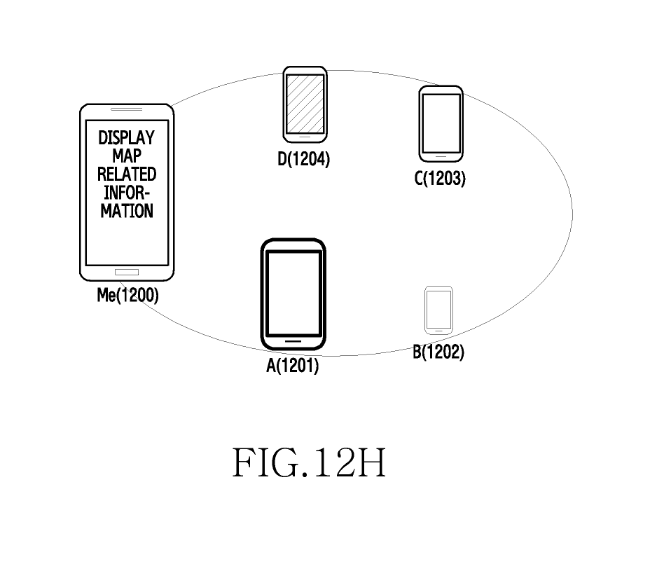

In accordance with aspects of the disclosure, at the time of transmitting a signal to a specific electronic device within a cluster, the electronic device may check a position of the specific electronic device based on the created map model, and control a magnitude of transmission power based on the checked position. For example, as illustrated in FIG. 12A, when assuming that a map model of an electronic device (Me) is constructed, the electronic device (Me) may set as 8 milliamperes (mA) a signal transmission power for an electronic device (B) located relatively closer compared to other electronic devices, and set as 10 mA a signal transmission power for an electronic device (D) located relatively farther compared the other electronic devices. Thus, in some implementations, the transmission power used by the electronic device in transmitting signals to the other devices in a cluster may be selected by the electronic devices based on the respective distances of the other devices to the electronic device.

In accordance with aspects of the disclosure, after creating the map model based on wireless short-range communication, in case that the electronic device (Me) uses other communication schemes (e.g., Bluetooth and P2P) to communicate with at least one electronic device within a cluster, the electronic device (Me) may also use the map model to control transmission power. In accordance with aspects of the disclosure, at the time of controlling transmission power for communication with other electronic devices within a cluster, the electronic device may also use only distance information between electronic devices acquired through first step to third step (101 to 105), instead of using the map model.

In accordance with aspects of the disclosure, the electronic device may transmit different information to respective electronic devices in accordance with positions of the electronic devices within a cluster. For example, as illustrated in FIG. 12B, an electronic device installed within a shop operates as an anchor master (AM) and forms a cluster with electronic devices (A), (B), (C), (D), and (E), and create a map model indicating that the electronic devices (D) and (E) are located inside the shop and the electronic devices (A), (B), and (C) are located outside the shop. The electronic device operating as the anchor master (AM) may transmit detailed information about a menu or goods of the shop to the electronic devices (D) and (E) located inside the shop, and transmit advertisement data to the electronic devices (A), (B), and (C) located outside the shop. In accordance with aspects of the disclosure, when intending to provide different information to the electronic devices within the cluster, the electronic device may also use only distance information between the electronic devices acquired the first step to third step (101 to 105), instead of using the map model. Thus, in some implementations, the anchor master (AM) may select the type of data to transmit to the various devices in the cluster based on the device's respective distances from the anchor master (AM).

In accordance with aspects of the disclosure, the electronic device may control functions of respective electronic devices in accordance with positions of the electronic devices within a cluster. For example, as illustrated in FIG. 12C, if it is determined that a smartwatch is located within 0.2 m through a map model, a smartphone may release a lock function of the smartphone through the map model. Also, if it is determined that the smartwatch is located in a distance farther than 0.2 m, the smartphone may activate the lock function of the smartphone. Also, if it is determined that the smartphone is located within 10 m through the map model, the smartwatch may release a lock function of the smartwatch. Also, if it is determined that the smartphone is located in a distance farther than 10 m, the smartwatch may activate the lock function of the smartwatch.

If it is determined that the smartwatch and the smartphone are located within 1 m through the map model, a car door may release a lock function of the car door. Also, if it is determined that at least one of the smartwatch and the smartphone is located in a distance farther than 1 m, the car door may activate the lock function of the car door.

In accordance with aspects of the disclosure, the electronic device may transmit map-related information indicating positions and/or distances of electronic devices within a cluster, to a server, and the server may provide a service based on the map-related information received from the electronic device. For example, as illustrated in FIG. 12D, if a map model indicating position and distance information of electronic devices (A) 1201, (B) 1202, (C) 1203, and (D) 1204 having performed time synchronization is created, the electronic device (Me) 1200 may transmit map-related information including position and/or distance information of the electronic devices (Me) 1200, (A) 1201, (B) 1202, (C) 1203, and (D) 1204, to a server 1210. The server 1210 may include a cloud being a server of a service provider, a server for a specific service, and other service provider servers. The server 1210 may analyze the map-related information received from the electronic device (Me) 1200 and, on the basis of the analysis result, the server 1210 may provide various services to the electronic 20 devices (Me) 1200, (A) 1201, (B) 1202, (C) 1203, and (D) 1204 or provide various services to non-shown other electronic devices. In accordance with aspects of the disclosure, the electronic device (Me) 1200 may provide map-related information including position and/or distance information of the electronic devices (Me) 1200, (A) 1201, (B) 1202, (C) 1203, and (D) 1204, to other electronic devices (e.g., electronic devices not included in a cluster). The other electronic devices receiving the map-related information from the electronic device (Me) 1200 may analyze the map-related information and, on the basis of the analysis result, provide various services to a user. The electronic device (Me) 1200 transmitting the map-related information to the server 1210 or other electronic devices may be an electronic device operating as an anchor master within a cluster, or may be other electronic devices not the anchor master within the cluster. The map-related information may include at least one information among information constructing a distance table, a map model, and/or map information according to aspects of the disclosure.

In accordance with aspects of the disclosure, the electronic device may transmit map-related information indicating position and/or distance information of electronic devices within a cluster, to a server, and the server may transmit the map-related information received from the electronic device, to other electronic devices. For example, as illustrated in FIG. 12E, if a map model indicating position and distance information of electronic devices (A) 1201, (B) 1202, (C) 1203, and (D) 1204 having performed time synchronization is created, the electronic device (Me) 1200 may transmit map-related information including the position and/or distance information of the electronic devices (Me) 1200, (A) 1201, (B) 1202, (C) 1203, and (D) 1204, to a server 1210. The server 1210 may include a cloud server and/or any other suitable type of server. The server 1210 may store the map-related information received from the electronic device (Me) 1200, and transmit the stored map-related information to the electronic device (E) 1220. The electronic device (E) 1220 may be an electronic device of a long range located in a position where discovery is impossible in the electronic devices (Me) 1200, (A) 1201, (B) 1202, (C) 1203, and (D) 1204. For instance, the electronic device (E) 1220 may be an electronic device which is located in a position in which cluster forming is impossible with the electronic device (Me) 1200 while desiring to receive the position of electronic devices located around the electronic device (Me) 1200.

In accordance with aspects of the disclosure, the electronic device (E) 1220 may send the server 1210 a request of transmission of map-related information of the electronic device (Me) 1200 through a service required by a user or an application being under execution, and receive the map-related information of the electronic device (Me) 1200 from the server 1210 in response to the request. In accordance with aspects of the disclosure, the electronic device (Me) 1200 may transmit the map-related information to the server 1210, while sending the server 1210 a request of transmission of the map-related information to the electronic device (E) 1220. The electronic device (Me) 1200 may be an electronic device operating as an anchor master within a cluster, or may be an electronic device not the anchor master within the cluster.

In accordance with aspects of the disclosure, the electronic device may provide time information synchronized with electronic devices within a cluster, to other electronic devices located in a long range, through a server (e.g., a cloud server), and perform synchronization with the other electronic devices located in the long range and electronic devices located around the other electronic devices. Also, the electronic device may share map-related information with synchronized at least one electronic device located in the long range. For example, as illustrated in FIG. 12F, the electronic device (Me) 1200 may perform time synchronization with the electronic devices (A) 1201, (B) 1202, (C) 1203, and D (1204), and transmit synchronized time information (e.g., synchronized clock information) to the electronic device (E) 1220 through the server 1210. The electronic device (E) 1220 may form a cluster with peripheral electronic devices (F) 1221, (G) 1222, (H) 1223, and (I) 1224 based on the synchronized time information of the electronic device (Me) 1200 received through the server 1210 and perform time synchronization with the peripheral electronic devices (F) 1221, (G) 1222, (H) 1223, and (I) 1224. The electronic device (E) 1220 may measure a distance based on a synchronized time and create a map model. The electronic device (Me) 1200 and the electronic device (E) 1220 each may exchange map-related information including position and/or distance information of electronic devices within a corresponding cluster, with each other through the server 1210.

The electronic device (Me) 1200 may be an electronic device operating as an anchor master within a corresponding cluster or may be other electronic device, not the anchor master within the cluster. In accordance with aspects of the disclosure, the electronic device (Me) 1200 and the electronic device (E) 1220 may exchange synchronized time information and map-related information through other communication technologies, instead of using the server 1210.

In accordance with aspects of the disclosure, the electronic device may sense a situation in which screen display of the electronic device is impossible, and provide map-related information including position and/or distance information of electronic devices within a cluster of the electronic device, to other electronic devices that are connected to the electronic device over a wired or wireless connection. The electronic device may send other electronic devices a request for displaying a graphic element indicating positions and/or distances of electronic devices within a cluster of the electronic device, based on map-related information. For example, as illustrated in FIG. 12G, the electronic device (Me) 1200 may determine that it is a situation in which screen display of the electronic device (Me) 1200 is currently impossible, although an event for displaying on a screen a graphic element indicating positions and/or distances of electronic devices within a cluster is sensed. In this case, the electronic device (Me) 1200 may transmit map-related information to other electronic devices 1230 that are connected with the electronic device (Me) 1200 over a wired or wireless connection, and request the other electronic devices 1230 to display a graphic element for positions and/or distances of electronic devices based on the map-related information.

The other electronic device 1230 connected with the electronic device (Me) 1200 may be any one of the electronic devices (A) 1201, (B) 1202, (C) 1203, and (D) 1204 constructing a cluster with the electronic device (Me) 1200, or may be other electronic device not included in the cluster. The electronic device (Me) 1200 may be an electronic device operating as an anchor master within a corresponding cluster, or may be other electronic device, not the anchor master within the cluster. The situation in which the screen display is impossible may be sensed, when an operation mode of the electronic device is a sleep mode, or a battery level of the electronic device is equal to or is less than a threshold value, or a data amount to be displayed is equal to or is greater than a data amount displayable on a screen by a threshold value or more. Or, in case that it is determined that a user is not using the electronic device (Me) 1200 although it is a situation in which the screen display is possible, the electronic device (Me) 1200 may transmit map-related information to other electronic devices that are connected with the electronic device (Me) 1200.

In accordance with aspects of the disclosure, the electronic device may control a display based on positions of electronic devices within a cluster. For example, as illustrated in FIG. 12H, the electronic device (Me) 1200 may perform displaying such that a user feels a sense of perspective, based on positions of electronic devices (A) 1201, (B) 1202, (C) 1203, and (D) 1204 within a cluster. For instance, the electronic device (Me) 1200 may large display the electronic device (A) 1201 having the shortest distance with the electronic device (Me) 1200, and small display the electronic device (B) 1202 having the longest distance with the electronic device (Me) 1200.

In another example, the electronic device (Me) 1200 may select an electronic device most suitable to an application being under execution or a service requested by a user, based on the positions of the electronic devices (A) 1201, (B) 1202, (C) 1203, and (D) 1204 within the cluster, and highlight and display a corresponding electronic device. For instance, the electronic device (Me) 1200 may identify that the electronic device (D) 1204 is located in a position most suitable to an application being under execution in the electronic device (Me) 1200, and highlight and display the electronic device (D) 1204. Herein, the highlighting and displaying may include displaying display color of the electronic device (D) 1204 differently from display color of the other electronic devices (A) 1201, (B) 1202, and (C) 1203, making different a display size of the electronic device (D) 1204 from display sizes of the other electronic devices (A) 1201, (B) 1202, and (C) 1203, or applying a specific graphic effect to the electronic device (D) 1204.

In a further example, when displaying the positions of the electronic devices (A) 1201, (B) 1202, (C) 1203, and (D) 1204 within the cluster on a basis of the electronic device (Me) 1200, the electronic device (Me) 1200 may display additional information about electronic devices within the cluster. The additional information may include information included in a packet received from a corresponding electronic device, such as the type of the corresponding electronic device and information collected through a sensor of the corresponding electronic device.

In accordance with aspects of the disclosure, fifth step (109) may be also omitted. According to the aforementioned FIG. 1, though fifth step (109) is omitted, the electronic device may estimate distances with other electronic devices having performed time synchronization and acquire relative position information.

In accordance with aspects of the disclosure, a way of using a beacon and/or service discovery frame transmitted/received within a discovery window to measure a distance has been described by way of example, but, in accordance with aspects of the disclosure, may also use other signals transmitted/received between electronic devices having performed time-synchronization.

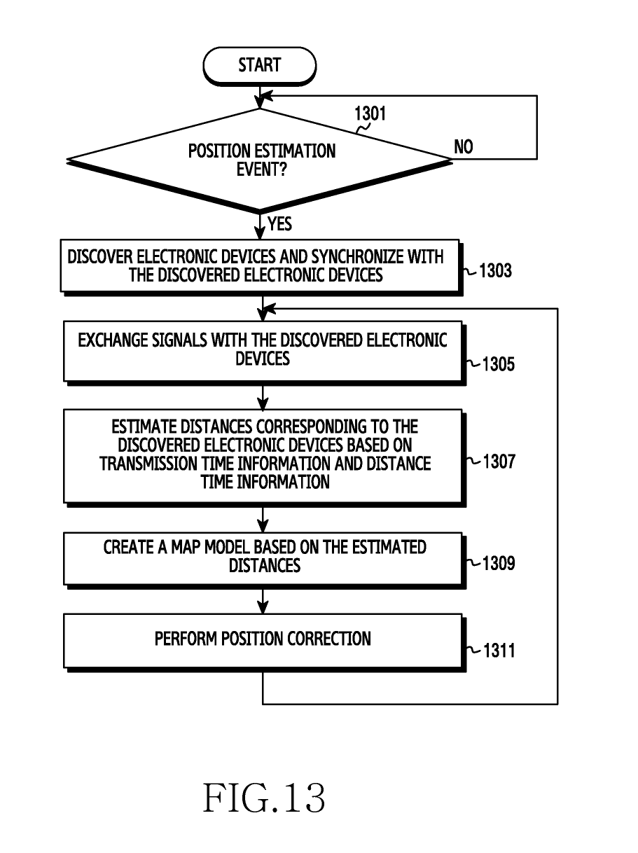

FIG. 13 is a flowchart of an example of a process, according to aspects of the disclosure.

Referring to FIG. 13, in operation 1301, the electronic device determines if a position estimation event takes place. The position estimation event may take place in response to an input from a user, based on a user's setting, and/or in response to the execution of an application providing (or needing) a location based service. Also, the position estimation event may be generated periodically.

In operation 1303, the electronic device may discover adjacent electronic devices, and perform synchronization with the discovered electronic devices. For example, the electronic device may periodically scan for discovery signals. The electronic device may recognize at least one adjacent electronic device and form a cluster with the adjacent at least one electronic device. In addition, the electronic device may perform time and channel synchronization with an electronic device within a cluster.

The electronic device may exchange information indicating a master preference with other electronic devices within a cluster, and perform time and channel synchronization on a basis of a time and channel of an electronic device having the highest master preference. The information indicating the master preference of each electronic device may be transmitted/received through any suitable type of signal, such as a discovery beacon, a synchronization beacon and/or a service discovery frame. In some instances, before the position estimation event for adjacent electronic devices takes place, the electronic device may form a cluster, and may perform time and channel synchronization with electronic devices within the cluster. In such instances, operation 1303 may be omitted.

In operation 1305, the electronic device may exchange a signal including transmission time information and distance information. The signal may be exchanged within a discovery window. For example, the electronic device may broadcast a beacon and/or service discovery frame including transmission time information within the discovery window. The transmission time information may represent a time for broadcasting the beacon and/or service discovery frame on a basis of a synchronized time. Also, the electronic device may receive beacons and/or service discovery frames including transmission time information from other electronic devices within a cluster. Additionally, the electronic device may include distance information with the other electronic devices in the beacon and/or service discovery frame including the transmission time information within the discovery window, and broadcast the beacon and/or service discovery frame. Also, the electronic device may receive beacons and/or service discovery frames including transmission time information and distance information between electronic devices from the other electronic devices within the cluster within the discovery window. In accordance with aspects of the disclosure, the electronic device may exchange a signal including at least one of the transmission time information and the distance information within the discovery window, based on a wireless short-range communication technology.

According to aspects of the disclosure, the electronic device may also exchange a signal including at least one of transmission time information and distance information, based on any other communication technologies, for example, communication technologies such as ultrasonic, BT, NFC, and Zigbee, other than a wireless short-range communication technology. For example, the electronic device may identify an available transmission medium based on at least one sensor, and determine a communication technology for transmitting a signal including at least one of transmission time information and distance information based on the kind of the identified transmission medium. For instance, in case that the electronic device is in water, the electronic device may use ultrasonic to exchange a signal including at least one of transmission time information and distance information with other electronic devices having performed synchronization.

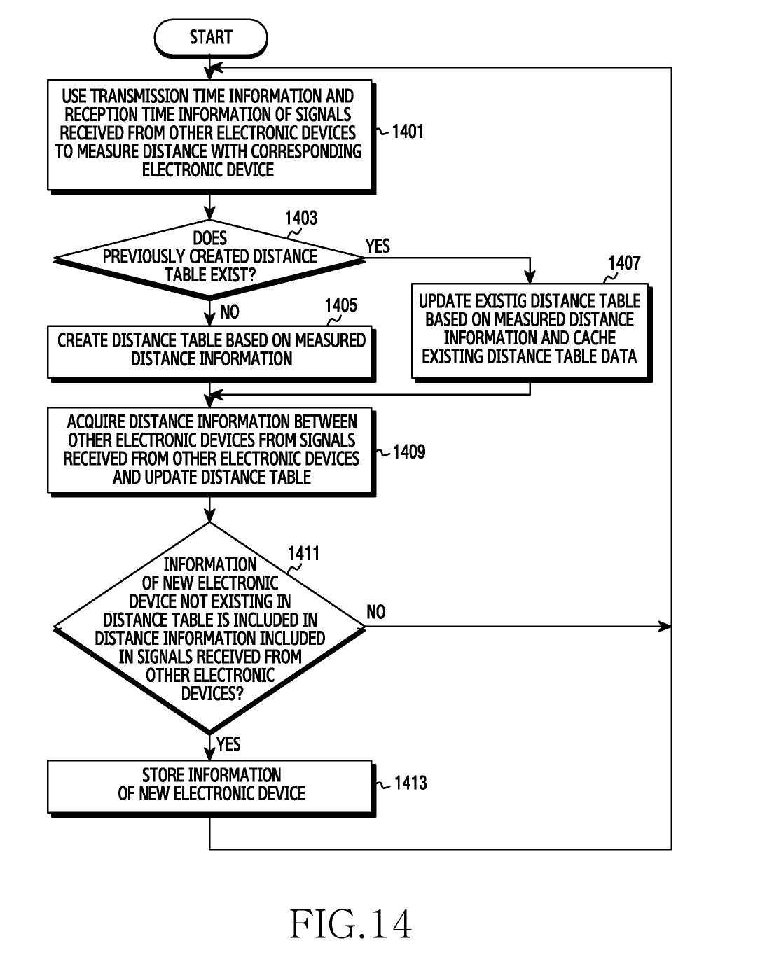

In operation 1307, the electronic device creates a distance table for electronic devices based on the transmission time information and the distance information received from the other electronic devices. For example, the electronic device may acquire the transmission time information from the beacons and/or service discovery frames received from the other electronic device within the discovery window. The electronic device may use Equation 1 above to estimate a distance between the electronic device and the other electronic devices based on a difference between a transmission time of the beacons and/or service discovery frames and a reception time. For example, the reception time may be measured at the time of reception of the beacons and/or service discovery frames in the electronic device. Also, the electronic device may acquire information about a distance between a corresponding electronic device and the other electronic devices from the beacons and/or service discovery frames received from the other electronic devices, and estimate a distance between the other electronic devices within the cluster. The electronic device may create a table indicating a distance between the electronic devices within the cluster based on the distance between the estimated electronic device and the other electronic devices, and the distance between the other electronic devices. An example of a process for creating the distance table is described below with reference to FIG. 14.

In operation 1309, the electronic device creates a map model indicating positions of the electronic device and the other electronic devices, based on the created distance table. For example, the electronic device may use the distance table to create the map model indicating the positions of the other electronic devices on a basis of its own position. For instance, the electronic device may set its own position coordinate as (0, 0), and estimate position coordinates of the other electronic devices on a basis of the position coordinate (0, 0) of the electronic device. To estimate the positions of the other electronic devices, the electronic device may determine at least one reference electronic device among the other electronic devices. The electronic device may first set a position of the reference electronic device, and estimate the positions of the other electronic devices based on position information of the electronic device and the reference electronic device, and create the map model.

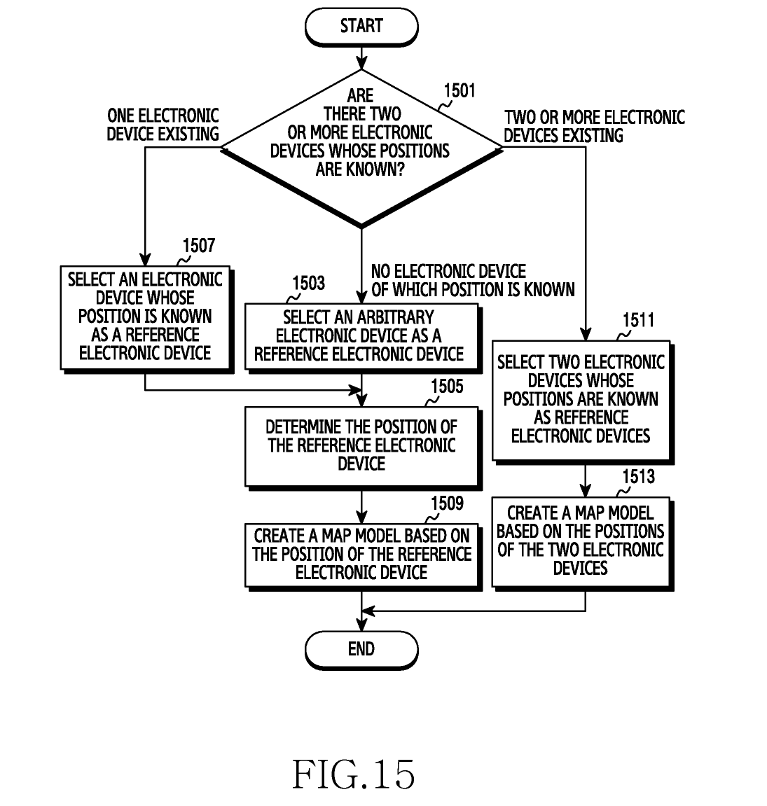

Next, in operation 1311, the electronic device performs position correction based on movement of the electronic device and/or setting of the electronic device. For example, the electronic device may accurately set a position of the reference electronic device based on the movement of the electronic device and/or the setting of the electronic device, and correct positions of the other electronic devices within the cluster based on a position of the electronic device and a position of the reference electronic device. Next, the electronic device may estimate the position of the reference electronic device based on at least one of a movement direction of the electronic device, a movement position, and a movement distance. As another example, the electronic device may use direction information inputted from a user through a touch sensor or direction information determined based on a camera and a direction sensor to estimate the position of the reference electronic device. For further example, the electronic device may use transmission/reception beam index information determined based on beam training with the reference electronic device and direction information of the electronic device to estimate the position of the reference electronic device. As yet another example, the electronic device may send the reference electronic device a request for position information transmission through other communication means (e.g., Bluetooth), and receive position information of the reference electronic device from the reference electronic device. For still another example, the electronic device may receive an input of position information of the reference electronic device through an input means (e.g., a touch sensor, a keypad, and a microphone) of the electronic device. An example of a process for correcting positions of electronic devices in the created map model is described below with reference to FIG. 15.

Next, the electronic device returns to operation 1305. For example, the electronic device may repeat and perform operation 1305 to operation 1311 until a user input for ending estimation of positions of other electronic devices is generated or an application providing a location based service is ended.

FIG. 14 is a flowchart of an example of a process for creating a distance table, according to aspects of the disclosure.

In operation 1401, the electronic device uses transmission time information and reception time information of signals received from other electronic devices to measure distances to the other electronic devices. For example, if beacons and/or service discovery frames including transmission time information are received from other electronic devices within synchronized discovery windows, the electronic device may measure a time at which the beacons and/or service discovery frames are received. The electronic device may acquire the transmission time information included in the received beacons and/or service discovery frames. The electronic device may measure distances with other electronic devices having transmitted the beacons and/or service discovery frames based on a difference between a transmission time and a reception time.

In operation 1403, the electronic device determines if a previously created distance table exists. If the previously created distance table does not exist, the electronic device proceeds to operation 1405 and creates a distance table based on the measured distance information. The distance table may include distance information about at least one other electronic device that has performed time synchronization with the electronic device. In contrast, if the previously created distance table exists, the electronic device proceeds to operation 1407 and updates an existing distance table based on the measured distance information, and caches data of the existing distance table.

In operation 1409, the electronic device acquires distance information associated with other electronic devices based on the signals received from the other electronic devices and updates the distance table. For example, according to aspects of the disclosure, the beacons and/or service discovery frames may include distance information between a corresponding electronic device and other electronic devices besides the transmission time information. Accordingly, the electronic device may acquire distance information associated with other electronic devices from the beacons and/or service discovery frames received within the discovery windows, and use the acquired distance information to update the distance table.

In operation 1411, the electronic device determines if information associated with a new electronic device that is not listed in the distance table is included in the distance information included in the signals received from the other electronic devices. For example, the electronic device may determine if distance information associated with the new electronic device not recognized by the electronic device exists, as a result of acquiring the distance information between the other electronic devices from the beacons and/or service discovery frames received every discovery window. If the information of the new electronic device is not included, the electronic device returns to operation 1401 and again performs the subsequent operations.

On the other hand, if the information of the new electronic device is included, in operation 1413, the electronic device stores the information of the new electronic device, and returns to operation 1401.

FIG. 15 is a flowchart of an example of process for creating a map model, according to aspects of the disclosure.

In operation 1501, the electronic device determines if there are other electronic devices whose positions are known among a plurality of other electronic devices. In accordance with aspects of the disclosure, if receiving beacons and/or service discovery frames additionally including the position of a corresponding electronic device besides transmission time information within discovery windows, the electronic device may acquire the position of the corresponding electronic device from the received beacons and/or service discovery frames.

According to aspects of the disclosure, the electronic device may request a user to set the position of at least one other electronic device, and previously acquire the position in response to the request. In one example, the electronic device may display on a screen a message requesting movement of the electronic device, and previously acquire the position of at least one electronic device based on a distance table changed according to movement of the electronic device caused by user motion. In another example, the electronic device may request to photograph a specific electronic device with a camera of the electronic device, and previously acquire the position of at least one electronic device based on the direction of the electronic device of a time point of photographing the specific electronic device and/or direction information of the camera and a distance table. Also, in a further example, the electronic device may request a user to set the direction of the specific electronic device, and previously acquire the position of at least one electronic device based on a touch direction sensed through a touch sensor and a distance table.

In accordance with aspects of the disclosure, the electronic device may previously acquire the position of at least one electronic device through other communication means. In accordance with aspects of the disclosure, the electronic device may perform beam training with at least one other electronic device supporting beamforming and acquire transmission/reception beam index information, and previously acquire the position of at least one electronic device based on a transmission/reception beam index and a distance table.

If failing to know the positions of all of the plurality of other electronic devices, the electronic device proceeds to operation 1503 and determines any one electronic device among the plurality of other electronic devices as a reference electronic device. For example, the electronic device may determine as the reference electronic device an electronic device that is the closest to the electronic device from among the plurality of other electronic devices. After determining the reference electronic device, in operation 1505, the electronic device determines a position of the reference electronic device based on movement of the electronic device. For example, the electronic device may use a distance table changed according to movement of the electronic device to determine the position of the reference electronic device. In accordance with aspects of the disclosure, to determine the position of the reference electronic device, the electronic device may prompt the user to move the electronic device.

In contrast, if the position of at least one other electronic device is known, in operation 1507, the electronic device determines as the reference electronic device one other electronic device whose position is known by the user of the electronic device.

In operation 1509, the electronic device creates a map model based on the position of the reference electronic device. For example, the electronic device may estimate positions of other electronic devices based on a position of the electronic device, a position of one reference electronic device, and a distance table, and create a map model. At this time, in case that two or more candidate positions are estimated for at least one other electronic device, the electronic device may perform position correction such as the aforementioned fifth step (109).

On the other hand, in case that the electronic device knows the position of two or more other electronic devices among the plurality of other electronic devices, in operation 1511, the electronic device determines as reference electronic devices two other electronic devices among two or more other electronic devices whose positions are known by the user. After that, in operation 1513, the electronic device creates a map model based on positions of the two reference electronic devices. For example, the electronic device may estimate positions of other electronic devices based on a position of the electronic device, positions of two reference electronic devices, and a distance table, and create a map model. Next, the electronic device terminates the map model creation procedure according to aspects of the disclosure.

According to aspects of the disclosure, a method may include the method of synchronizing a apparatus with at least one electronic device, receiving a signal from the electronic device, and determining a distance between the apparatus and the electronic device based on a transmission time and a reception time of the signal.

According to aspects of the disclosure, the method may further include the method of scanning a discovery signal broadcasted from the electronic device every certain period, receiving the discovery signal from the electronic device, forming a group with the electronic device corresponding to the received discovery signal, and performing the synchronization with the electronic device.

According to aspects of the disclosure, the received signal from the electronic device that is a member of the group comprises at least one of the transmission time, a position of the electronic device, availability of beamforming support in the electronic device, a transmission/reception beam index of the electronic device, and a distance between the electronic device and another electronic device that is also a member of the group.

According to aspects of the disclosure, the method may further include the method of determining a position of the electronic device based on a distance between the apparatus and the electronic device, and a distance between each of the electronic devices in the group.

According to aspects of the disclosure, the determining the position of the electronic device comprising, sensing a movement of the apparatus, determining the position of the electronic device based on at least one of a movement direction and a movement distance changed by the movement of the apparatus.

According to aspects of the disclosure, the determining the position of the electronic device comprises, determining a reference electronic device among the electronic device in the group, acquiring a position of the reference electronic device, and determining the position of the electronic device, based on a positions of the apparatus and the reference electronic device, the distance between the apparatus and the electronic device, and the distance between each of the electronic devices in the group.

According to aspects of the disclosure, the method may further include the operations of sensing a type of an available transmission medium and selecting a communications scheme for exchanging information with the electronic device based on the type of the transmission medium.

According to aspects of the disclosure, the method may further include the method of transmitting the distance to other electronic devices connected with the apparatus, based on at least one of an operation mode of the apparatus, an amount of data to be displayed, and a battery level of the apparatus.

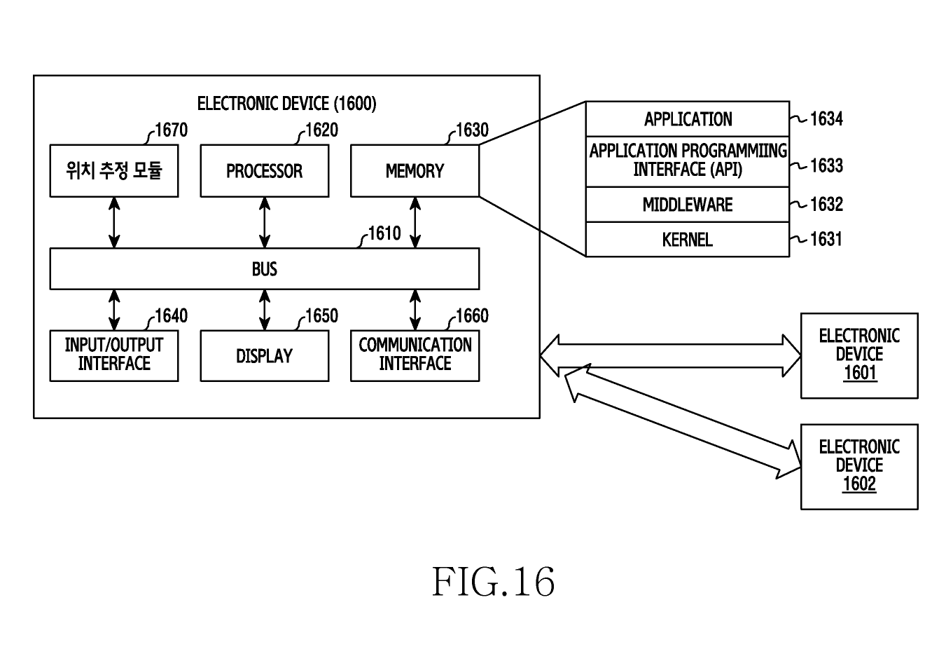

FIG. 16 is a diagram of an example of a network environment, according to aspects of the disclosure.

Referring to FIG. 16, the electronic device 1600 may include a bus 1610, a processor 1620, a memory 1630, an input/output interface 1640, a display 1650, a communication interface 1660, a position estimation module 1670.

The bus 1610 may be a circuit connecting the aforementioned constituent elements of the electronic device 1600 with one another and forwarding communication (e.g., a control message) between the aforementioned constituent elements of the electronic device 1600.

The processor 1620 may, for example, receive instructions from the aforementioned other constituent elements (e.g., the memory 1630, the input/output interface 1640, the display 1650, the communication interface 1660, or the position estimation module 1670) through the bus 1610, and decipher the received instructions, and execute operation or data processing according to the deciphered instructions.

The memory 1630 may store an instruction or data that is received from the processor 1620 or the other constituent elements (e.g., the input/output interface 1640, the display 1650, the communication interface 1660, the position estimation module 1670, the speaker 1680, or the microphone 1690) or is generated by the processor 1620 or the other constituent elements. The memory 1630 may include, for example, programming modules such as a kernel 1631, a middleware 1632, an Application Programming Interface (API) 1633, or an application 1634. Herein, the aforementioned programming modules each may consist of software, firmware, hardware or a combination of at least two or more of them.

The input interface 1640 may forward an instruction or data inputted from a user through an input device (e.g., a sensor, a keyboard or a touch screen), for example, to the processor 1620, the memory 1630, the communication interface 1660, or the position estimation module 1670 through the bus 1610. For example, the input interface 1640 may provide data about a user's touch inputted through a touch screen, to the processor 1620.

The display 1650 may display various information (e.g., multimedia data or text data) to a user. For example, the display 1650 may display an instruction or data received from the processor 1620, the memory 1630, the communication interface 1660, or the position estimation module 1670 through the bus 1610. For example, the display 1650 may display a map model created by the position estimation module 1670. For example, the display 1650 may display an interface for setting the position of at least one electronic device in accordance with control of the position estimation module 1670.

The communication interface 1660 may establish communication between the electronic device 1600 and an external device (e.g., electronic devices 1601, 1602 or a server (not shown)). For example, the communication interface 1660 may be connected to a network through wireless communication or wired communication, to communicate with the external device. The wireless communication may include, for example, at least one of WiFi, NAN, BT, NFC, ultrasonic communication, satellite communication (e.g., a GPS) or cellular communication (e.g., Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM)). The wired communication may include, for example at least one of a Universal Serial Bus (USB), a High Definition Multimedia Interface (HDMI), a Recommended Standard-232 (RS-232), or a Plain Old Telephone Service (POTS).

According to aspects of the disclosure, the network may be a telecommunications network. The telecommunications network may include at least one of a computer network, the Internet, internet of things, or a telephone network. According to aspects of the disclosure, a protocol (e.g., a transport layer protocol, a data link layer protocol, or a physical layer protocol) for communication between the electronic device 1600 and the external device may be supported in at least one of the application 1634, the application programming interface 1633, the middleware 1632, the kernel 1631 which are included in the memory 1630, or the communication interface 1660.

The communication interface 1660 may use a wireless short-range communication technology to discover other electronic devices, and form a cluster with the discovered at least one other electronic device and perform time and channel synchronization. The communication interface 1660 may transmit beacons and/or service discovery frames within synchronized discovery windows. The communication interface 1660 may receive beacons and/or service discovery frames within synchronized discovery windows. The beacons and/or service discovery frames may include at least one of transmission time information, distance information between the electronic device 1600 and the other electronic devices 1601 and 1602, the position of the electronic device 1600, and MIMO related information (e.g., beamforming support or non-support, and transmission/reception beam index information).

In accordance with aspects of the disclosure, the communication interface 1660 may load the transmission time information, the distance information, the position information and the MIMO related information on ultrasonic and transmit the loaded transmission time information, distance information, position information and MIMO related information to other electronic devices having performed synchronization. The communication interface 1660 may receive transmission time information, distance information, position information and MIMO related information of other electronic devices through ultrasonic. The communication interface 1660 may transmit map-related information to the server (not shown), or receive map-related information of other electronic devices from the server (not shown).

The position estimation module 1670 performs a function for measuring a distance between electronic devices within a cluster formed using a wireless short-range communication technology, and estimating positions of the electronic devices based on the measured distance.

According to aspects of the disclosure, the position estimation module 1670 may acquire transmission time information from beacons and/or service discovery frames received within discovery windows by the communication interface 1660, and acquire reception time information at which the beacons and/or service discovery frames are received, and measure a distance between the electronic device and other electronic devices based on a difference between a transmission time and a reception time.

According to aspects of the disclosure, the position estimation module 1670 may use the measured distance to create a distance table indicating a distance of electronic devices within a cluster. The position estimation module 1670 may use the distance information acquired from the beacons and/or service discovery frames received within the discovery windows to update the distance table.

According to aspects of the disclosure, the position estimation module 1670 may create a map model indicating positions of electronic devices within a cluster based on the distance table. The position estimation module 1670 may acquire the position of at least one electronic device. For example, the position estimation module 1670 may acquire the position of a corresponding electronic device from the beacons and/or service discovery frames received within the discovery windows. For another example, the position estimation module 1670 may acquire the position of a specific electronic device based on direction information of the electronic device 1600 and the distance table. The direction information of the electronic device 1600 may be acquired from a sensor (not shown) at a time point of photographing the specific electronic device.

Also, the position estimation module 1670 may acquire the position of a specific electronic device based on a transmission/reception beam index determined through beam training of the electronic device 1600, direction information of the electronic device 1600 at beam training, and a distance table. Also, the position estimation module 1670 may acquire the position of the specific electronic device based on a movement direction of the electronic device and a distance table. Also, the position estimation module 1670 may acquire the position of the specific electronic device based on a touch direction sensed through the input/output interface 1640 of the electronic device and the distance table. Also, the position estimation module 1670 may receive the position of the specific electronic device through a specific communication means of the communication interface 1660.

According to aspects of the disclosure, the position estimation module 1670 may correct a position of at least one electronic device within a map model based on the acquired the position of the at least one electronic device.

According to aspects of the disclosure, the position estimation module 1670 and/or the processor 1620 may control a function for performing exemplary embodiments related to location-based service provision described in the aforementioned sixth step (111) of FIG. 1.

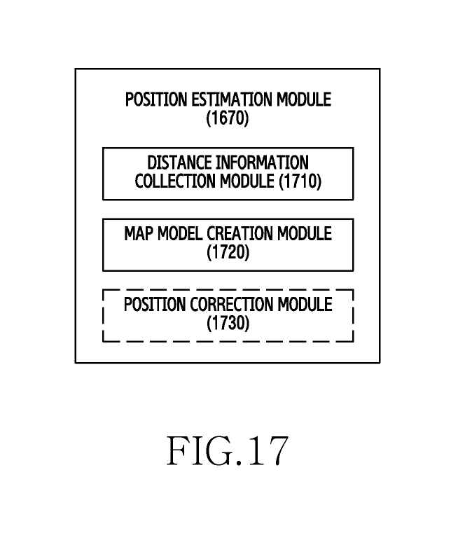

FIG. 17 is a diagram of an example of a position estimation module, according to aspects of the disclosure.

According to aspects of the disclosure, the position estimation module 1670 may include a distance information collection module 1710 and a map model creation module 1720, and additionally include a position correction module 1730.

The distance information collection module 1710 may exchange time and distance information with at least one other electronic device having performed time synchronization. According to aspects of the disclosure, the distance information collection module 1710 may control a function for broadcasting beacons and/or service discovery frames including transmission time information. According to aspects of the disclosure, the distance information collection module 1710 may control a function for receiving beacons and/or service discovery frames including transmission time information from other electronic devices within a cluster. The distance information collection module 1710 may receive beacons and/or service discovery frames including transmission time information from other electronic devices, and measure distances with the other electronic devices. For example, the distance information collection module 1710 may acquire the transmission time information from the beacons and/or service discovery frames received from the other electronic devices, and measure distances with the other electronic devices based on the acquired transmission time information and/or time information at which the beacons and/or service discovery frames are received, as in Equation 1 above.

The distance information collection module 1710 may include distance information with other electronic devices in beacons and/or service discovery frames including transmission time information, and broadcast the beacons and/or service discovery frames. Also, the distance information collection module 1710 may include its own position in the beacons and/or service discovery frames including transmission time information, and broadcast the beacons and/or service discovery frames. The distance information collection module 1710 may include its own MIMO related information (e.g., beamforming support or non-support and transmission/reception beam index information) in the beacons and/or service discovery frames including transmission time information, and broadcast the beacons and/or service discovery frames.

The distance information collection module 1710 may construct a distance table indicating a distance between electronic devices having performed time synchronization, based on time and distance information exchanged with at least on other electronic device.

The distance information collection module 1710 may receive distance information about a new electronic device not recognized by the electronic device, in beacons and/or service discovery frames received every discovery window. If the distance information about the new electronic device not recognized by the electronic device is received, the distance information collection module 1710 may separately store and manage the distance information about the new electronic device, as a hidden node, without discarding the distance information about the new electronic device.

The map model creation module 1720 creates a map model indicating positions of a plurality of electronic devices based on a distance table created in the distance information collection module 1710. The map model creation module 1720 may use the distance table to create the map model indicating the positions of other electronic devices on a basis of its own position.

To estimate the positions of the other electronic devices, the map model creation module 1720 may determine at least one reference electronic device among the other electronic devices. In accordance with aspects of the disclosure, the map model creation module 1720 may determine as reference electronic devices other electronic devices whose positions are acquired through beacons and/or service discovery frames among other electronic devices (for instance, other electronic devices of which information exist in a distance table) included in a cluster.

In accordance with aspects of the disclosure, the map model creation module 1720 may determine as a reference electronic device an electronic device having the shortest distance with the electronic device among other electronic devices included in a cluster. In accordance with aspects of the disclosure, the map model creation module 1720 may determine as the reference electronic device an electronic device whose position estimation is possible using information (e.g., MIMO related information) included in the beacons and/or service discovery frames among the other electronic devices included in the cluster.

In accordance with aspects of the disclosure, the map model creation module 1720 may arbitrarily select at least one electronic device among the other electronic devices included in the cluster, and determine the selected electronic device as a reference electronic device. The map model creation module 1720 may determine positions of other electronic devices based on a distance table and positions of the electronic device and the reference electronic device.

The position correction module 1730 may correct a position of at least one electronic device in a map model constructed to indicate positions of a plurality of electronic devices. For example, if a position of at least one electronic device is an inaccurate position in a map model created in the map model creation module 1720, the position correction module 1730 may correct the inaccurate position of the electronic device.

In accordance with aspects of the disclosure, if a distance table is updated due to movement of the electronic device, the position correction module 1730 may correct a map model based on a movement direction of the electronic device and an updated distance table. In accordance with aspects of the disclosure, the position correction module 1730 may acquire the position of a reference electronic device based on movement of a terminal caused by user motion and correct positions of electronic devices included in the map model.

In accordance with aspects of the disclosure, the position correction module 1730 may acquire accurate the position of at least one electronic device based on user input, and correct positions of electronic devices included in the map model. For example, the position correction module 1730 may request a user of the electronic device to look at an electronic device whose position is known by the user with a camera of the electronic device. If the camera of the electronic device faces a specific electronic device, the position correction module 1730 may check the direction of the electronic device and camera direction information. The electronic device may use the checked direction information to determine the direction in which the specific electronic device is located, and estimate a position of the specific electronic device based on the determined direction and map information stored at the time of map model creation.

For another example, the position correction module 1730 may request a user to set the direction of an electronic device whose position is known by the user, and set the direction of a specific electronic device based on a direction in which a screen is touched. If the direction in which the specific electronic device is located is determined, the position correction module 1730 may estimate a position of the specific electronic device based on the determined direction and map information stored at the time of map model creation. The position correction module 1730 may correct a position of at least one other electronic device in a map model based on the estimated position of the specific electronic device.

In accordance with aspects of the disclosure, if there is a specific electronic device whose position is previously known by the electronic device through any other means other than a beacon and/or service discovery frame among electronic devices within a cluster, the position correction module 1730 may use position information of the specific electronic device to correct a position of at least one electronic device included in a map model. The position correction module 1730 may use other communication means (e.g., Bluetooth) to send a request for transmission of the position information to at least one electronic device among electronic devices within a cluster, and receive position information from the corresponding electronic device. The position correction module 1730 may use received position information to correct a position of at least one electronic device included in a map model. At this time, the position correction module 1730 may display a screen for setting of other communication means (e.g., requesting of setting of turning On a Bluetooth function) necessary for receiving position information.

In accordance with aspects of the disclosure, if the electronic device supports a beamforming technology, and at least one electronic device among electronic devices within a cluster supports the beamforming technology, the position correction module 1730 may perform beam training with the electronic device supporting the beamforming technology. According to the beam-training execution result, the position correction module 1730 may check the direction in which a corresponding electronic device is located on a basis of the electronic device. For example, the position correction module 1730 may perform beam training with a specific electronic device within a cluster and determine a transmission/reception beam index of the electronic device. The position correction module 1730 may check the direction of the specific electronic device, based on the determined transmission/reception beam index and direction information of the electronic device acquirable through a sensor. If the direction in which the specific electronic device is located is determined, the position correction module 1730 may estimate a position of the specific electronic device based on the determined direction and map information stored at the time of map model creation. The position correction module 1730 may correct a position of at least one other electronic device in a map model based on the estimated position of the specific electronic device.

According to aspects of the disclosure, an apparatus may include a communication interface, and at least one processor configured to synchronize the apparatus with at least one electronic device, receive, via the communication interface, a signal from the electronic device, and determine a distance between the apparatus and the electronic device based on a transmission time and a reception time of the signal.

According to aspects of the disclosure, the processor may scans a discovery signal broadcasted from the electronic device every certain period, receives the discovery signal from the electronic device, forms a group with the electronic device corresponding to the received discovery signal and performs the synchronization with the electronic device.

According to aspects of the disclosure, the received signal from the electronic device that is a member of the group comprises at least one of the transmission time, a position of the electronic device, availability of beamforming support in the electronic device, a transmission/reception beam index of the electronic device, and a distance between the electronic device and another electronic device that is also a member of the group.

According to aspects of the disclosure, the processor may determines a position of the electronic device based on a distance between the apparatus and the electronic device, and a distance between each of the electronic devices in the group.

According to aspects of the disclosure, the electronic device may further include at least one sensor for sensing a movement of the apparatus, wherein the processor is configured to determine the position of the electronic device based on at least one of a movement direction and a movement distance changed by the movement of the apparatus.

According to aspects of the disclosure, the processor may determines a reference electronic device among the electronic device in the group, acquires a position of the reference electronic device and determine the position of the electronic device, based on a positions of the apparatus and the reference electronic device, the distance between the apparatus and the electronic device, and the distance between each of the electronic devices in the group.

According to aspects of the disclosure, the processor may acquires the position of the reference electronic device based on a receive signal from the reference electronic device, or a changed distance between the apparatus and the reference electronic device by a movement of the apparatus.

According to aspects of the disclosure, the electronic device may further include a camera and a display for displaying a screen for setting the position of the third electronic device, wherein the processor is further configured to acquire a direction in which the reference electronic device is located, based on at least one of a movement direction of the apparatus, orientation of the apparatus, orientation of the camera, a touch direction, and a user input; and determine the position of the reference electronic device based on the acquired direction.

According to aspects of the disclosure, the processor may determines a transmission/reception beam index by performing beam training with the reference electronic device, acquire a direction in which the reference electronic device is located, based on at least one of the orientation of the apparatus, the determined beam index and determine the position of the reference electronic device based on the acquired direction.

According to aspects of the disclosure, the processor may determines at least one of a transmission power of the apparatus, transmission data, and a function to be performed, based on the distance between the apparatus and the electronic device.

According to aspects of the disclosure, the electronic device may further include at least one sensor for sensing a type of an available transmission medium, wherein the at least one processor is further configured select a communications scheme for exchanging information with the electronic device based on the type of the transmission medium.

According to aspects of the disclosure, the processor may transmits the distance to other electronic devices connected with the apparatus, based on at least one of an operation mode of the apparatus, an amount of data to be displayed, and a battery level of the apparatus.

According to aspects of the disclosure, in a storage medium storing instructions, the instructions are set such that at least one processor performs at least one operation when the instructions are executed by the at least one processor. The at least one operation may include operations of, in the electronic device, transmitting or receiving at least one signal among a first signal corresponding to a first communication network or a second signal corresponding to a second communication network and, if receiving the at least one signal, distributing the at least one signal to each of a first communication control module for processing a first signal and a second communication control module for processing a second signal, based on the fact that a service provided by the electronic device corresponds to a first signal and a second signal.

In a wireless short-range communication system according to aspects of the disclosure, an electronic device may acquire transmission time information from a signal broadcasted from at least one other electronic device having performed synchronization, and measure a distance with the at least one other electronic device based on the acquired transmission time information, thereby reducing a time and current consumption amount required for distance measurement.

Also, in a wireless short-range communication system according to aspects of the disclosure, an electronic device may exchange a signal including transmission time information with at least one other electronic device having performed synchronization, and measure a distance between the electronic devices, and estimate a position of the at least one other electronic device based on the measured distance, thereby providing various position-based services.

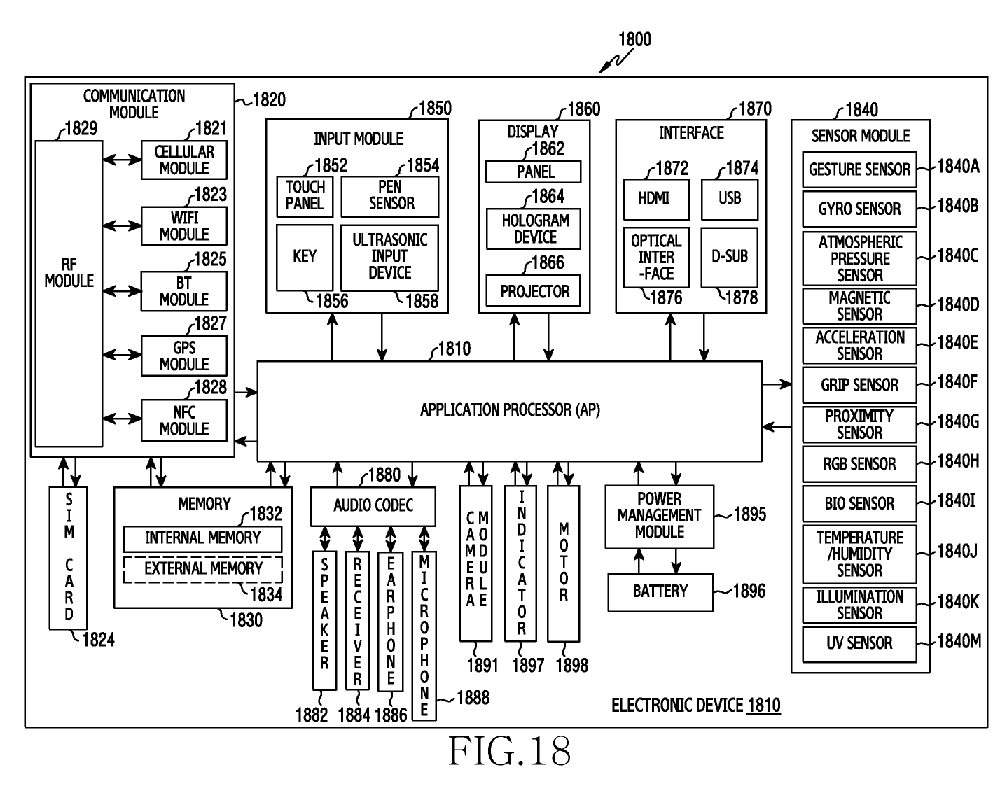

FIG. 18 is a block diagram 200 of an example of an electronic device 1801, according to aspects of the disclosure. The electronic device 1801 can configure whole or part of the electronic device 101 of FIG. 16. Referring to FIG. 18, the electronic device 1801 can include one or more Application Processors (APs) 1110, a communication module 1820, a Subscriber Identification Module (SIM) card 1824, a memory 1830, a sensor module 1840, an input device 1850, a display 1860, an interface 1870, an audio module 1880, a camera module 1891, a power management module 1895, a battery 1896, an indicator 1897, and a motor 1898.

The AP 1110 can control hardware or software components connected to the AP 1110 by driving an operating system or an application program, and carry out various data processing and operations including multimedia data. The AP 1110 can be implemented using, for example, a System on Chip (SoC). The AP 1110 can further include a Graphic Processing Unit (GPU) (not shown).

The communication module 1820 (e.g., the communication interface 160) can transmit and receive data in the communication between the electronic device 1801 (e.g., the electronic device 101) and the other electronic devices (e.g., the electronic device 104 or the server 106) connected over the network. The communication module 1820 can include a cellular module 1821, a Wifi module 1823, a BT module 1825, a GPS module 1827, an NFC module 228, and a Radio Frequency (RF) module 1829.

The cellular module 1821 can provide a voice call, a video call, a text message service, or an Internet service over the communication network (e.g., LTE, LTE-A, CDMA, WCDMA, UMTS, WiBro, or GSM). Also, the cellular module 1821 can identify and authenticate the electronic device in the communication network using the SIM (e.g., the SIM card 1824). The cellular module 1821 can perform at least part of functions provided by the AP 1110. For example, the cellular module 1821 can perform at least part of a multimedia control function.

The cellular module 1821 can include a Communication Processor (CP). The cellular module 1821 can be implemented using, for example, the SoC. While the components of the cellular module 1821 (e.g., the CP), the memory 1830, and the power management module 1895 are separated from the AP 1110 in FIG. 2, the AP 1110 can include at least part (e.g., the cellular module 1821) of the above-stated components.

The AP 1110 or the cellular module 1821 (e.g., the CP) can load and process the instruction or the data received from its connected non-volatile memory or at least one of the other components, in a volatile memory. Also, the AP 1110 or the cellular module 1821 can store data received from or generated by at least one of the other components, in the non-volatile memory.

The Wifi module 1823, the BT module 1825, the GPS module 1827, or the NFC module 228 each can include, for example, a processor for processing the data transmitted and received via the corresponding module. While the cellular module 1821, the Wifi module 1823, the BT module 1825, the GPS module 1827, and the NFC module 228 are separated from each other in FIG. 2, at least part (e.g., at least two) of the cellular module 1821, the Wifi module 1823, the BT module 1825, the GPS module 1827, and the NFC module 228 can be included in a single Integrated Chip (IC) or an IC package. For example, at least part (e.g., the CP corresponding to the cellular module 1821 and the Wifi processor corresponding to the Wifi module 1823) of the processors corresponding to the cellular module 1821, the Wifi module 1823, the BT module 1825, the GPS module 1827, and the NFC module 228 can be implemented using a single SoC.

The RF module 1829 can transmit and receive the data, for example, RF signals. The RF module 1829 can include, for example, a transceiver, a Power Amp Module (PAM), a frequency filter, and a Low Noise Amplifier (LNA), which are not shown. Also, the RF module 1829 can further include a component, for example, a conductor or a conducting wire, for sending and receiving electromagnetic waves in free space during the wireless communication. While the cellular module 1821, the Wifi module 1823, the BT module 1825, the GPS module 1827, and the NFC module 228 share the single RF module 1829 in FIG. 2, at least one of the cellular module 1821, the Wifi module 1823, the BT module 1825, the GPS module 1827, and the NFC module 228 can transmit and receive the RF signals via a separate RF module.

The SIM card 1824 can be a card including the SIM and inserted to a slot formed at a specific location of the electronic device. The SIM card 1824 can include unique identification information (e.g., Integrated Circuit Card Identifier (ICCID)) or subscriber information (e.g., International Mobile Subscriber Identity (IMSI)).

The memory 1830 (e.g., the memory 130) can include an internal memory 1832 or an external memory 1834. For example, the internal memory 1832 can include at least one of the volatile memory (e.g., Dynamic RAM (DRAM), Static RAM (SRAM), Synchronous Dynamic RAM (SDRAM)) and the non-volatile memory (e.g., One-Time Programmable ROM (OTPROM), Programmable ROM (PROM), Erasable and Programmable ROM (EPROM), Electrically Erasable and Programmable ROM (EEPROM), mask ROM, flash ROM, NAND flash memory, and NOR flash memory). The internal memory 1832 can be a Solid State Drive (SSD). The external memory 1834 can include a flash drive, for example, a Compact Flash (CF), a Secure Digital (SD), a Micro-Secure Digital (SD), a Mini-SD, an extreme digital (xD), or a memory stick. The external memory 1834 can be functionally connected to the electronic device 1801 via various interfaces. The electronic device 1801 can further include a storage device (or a storage medium) such as hard drive.

The sensor module 1840 can measure a physical quantity or detect an operation status of the electronic device 1801, and convert the measured or detected information to an electric signal. The sensor module 1840 can include at least one of, for example, a gesture sensor 1840A, a gyro sensor 1840B, an atmospheric pressure sensor 1840C, a magnetic sensor 1840D, an acceleration sensor 1840E, a grip sensor 1840F, a proximity sensor 1840G, a color sensor 1840H (e.g., Red Green Blue (RGB) sensor), a biometric sensor 1840I, a temperature/humidity sensor 1840J, a light sensor 1840K, or an UltraViolet (UV) sensor 1840M. Additionally or alternatively, the sensor module 1840 can include, for example, an E-noise sensor (not shown), an electromyography (EMG) sensor (not shown), an electroencephalogram (EEG) sensor (not shown), an electrocardiogram (ECG) sensor (not shown), an Infra Red (IR) sensor (not shown), an iris sensor (not shown), or a fingerprint sensor (not shown). The sensor module 1840 can further include a control circuit for controlling its one or more sensors.

The input device 1850 can include a touch panel 1852, a (digital) pen sensor 1854, a key 1856, or an ultrasonic input device 1858. For example, the touch panel 1852 can recognize touch input using at least one of capacitive, resistive, infrared, and ultrasonic wave techniques. Also, the touch panel 1852 may further include a controller. The capacitive type can recognize physical contact or proximity. The touch panel 1852 may further include a tactile layer. In this case, the touch panel 1852 can provide a tactile response to the user.

The (digital) pen sensor 1854 can be implemented using, for example, the same or similar method as or to the user's touch input, or using a separate recognition sheet. For example, the key 1856 can include, for example, a physical button, an optical key, or a keypad. The ultrasonic input device 1858 is a device capable of obtaining data by detecting microwaves through a microphone (e.g., a microphone 1888) in the electronic device 1801 through an input tool which generates an ultrasonic signal, allows radio frequency identification. The electronic device 1801 may receive user input from an external device (e.g., a computer or a server) connected using the communication module 1820.

The display 1860 (e.g., the display 150) can include a panel 1862, a hologram device 1864, or a projector 1866. The panel 1862 can employ, for example, a Liquid-Crystal Display (LCD) or an Active-Matrix Organic Light-Emitting Diode (AMOLED). The panel 1862 can be implemented, for example, flexibly, transparently, or wearably. The panel 1862 may be constructed as the single module with the touch panel 1852. The hologram device 1864 can present a three-dimensional image in the air using interference of light. The projector 1866 can display the image by projecting the light onto a screen. The screen can be placed, for example, inside or outside the electronic device 1801. The display 1860 can further include a control circuit for controlling the panel 1862, the hologram device 1864, or the projector 1866.

The interface 1870 can include, for example, a High-Definition Multimedia Interface (HDMI) 272, a Universal Serial Bus (USB) 274, an optical interface 1876, or a D-subminiature (D-sub) 278. The interface 1870 can be included in, for example, the communication interface 160 of FIG. 1. Additionally/alternatively, the interface 1870 can include, for example, Mobile High-Definition Link (MHL) interface, Secure Digital (SD) card/Multi-Media Card (MMC) interface, or Infrared Data Association (IrDA) standard interface.

The audio module 1880 can convert sound to an electric signal and vice versa. At least part of the audio module 1880 can be included in, for example, the input/output interface 140 of FIG. 1. The audio module 1880 can process sound information which is input or output through, for example, a speaker 1882, a receiver 1884, an earphone 1886, or the microphone 1888.

The camera module 1891 is a device for capturing a still picture and a moving picture, and can include one or more image sensors (e.g., a front sensor or a rear sensor), a lens (not shown), an Image Signal Processor (ISP) (not shown), or a flash (e.g., LED or xenon lamp) (not shown).

The power management module 1895 can manage power of the electronic device 1801. The power management module 1895 can include, although not depicted, for example, a Power Management Integrated Circuit (PMIC), a charger Integrated Circuit (IC), or a battery fuel gauge.

The PMIC can be mounted in, for example, an IC or a SoC conductor. The charging type can be divided to a wired type and a wireless type. The charger IC can charge the battery, and prevent overvoltage or overcurrent flow from the charger. The charger IC can include a charger IC for at least one of the wired charging type or the wireless charging type. The wireless charging type includes, for example, a magnetic resonance type, a magnetic induction type, or a microwave type, and can add an additional circuit for the wireless charging, for example, a circuit such as coil loop, resonance circuit, or rectifier.

The battery gauge can, for example, measure the remaining capacity of the battery 1896 and the voltage, the current, or the temperature of the charging. The battery 1896 can generate or store electricity, and supply the power to the electronic device 1801 using the stored or generated electricity. The battery 1896 can include, for example, a rechargeable battery or a solar battery

The indicator 1897 can display a specific status of the electronic device 1801 or its part (e.g., the AP 1110), for example, booting state, message state, or charging state. The motor 1898 can convert the electric signal to a mechanic vibration. Although it is not depicted, the electronic device 1801 can include a processing device (e.g., a GPU) for mobile TV support. The processing device for the mobile TV support can process media data in conformity to a standard, for example, Digital Multimedia Broadcasting (DMB), Digital Video Broadcasting (DVB), or media flow.

The aforementioned components of the electronic device according to aspects of the disclosure each can include one or more components, and the name of the corresponding component can differ according to the type of the electronic device. The present electronic device can include at least one of the aforementioned components, omit some components, or further include other components. Also, some of the components of the present electronic device can be united into a single entity to thus carry out the same functions of the corresponding components.

The term “module” as used throughout the disclosure may, for example, represent a unit including one of hardware, software, or firmware or a combination of two or more thereof. The “module” may be, for example, used interchangeably with the terms “unit”, “logic”, “logical block”, “component”, or “circuit”, etc. The “module” may be the minimum unit of an integrally constructed component or part thereof. The “module” may be the minimum unit performing one or more functions or part thereof as well. The “module” may be implemented mechanically or electronically. For example, the “module,” according to aspects of the disclosure, may include at least one of an Application-Specific Integrated Circuit (ASIC) chip, Field-Programmable Gate Arrays (FPGAs) or a programmable-logic device performing some operations, which have been known to the art or will be developed in the future.

According to aspects of the disclosure, at least a part of an apparatus (e.g., modules or functions thereof) or method (e.g., operations) according to aspects of the disclosure may be, for example, implemented by instructions stored in a computer-readable storage media in a form of a programming module. When the instruction is executed by one or more processors (e.g., the processor 1620), the one or more processors may perform functions corresponding to the instructions. The computer-readable storage media may be, for instance, the memory 1630. At least a part of the programming module may be, for example, implemented (e.g., executed) by the processor 1620. At least a part of the programming module may, for example, include a module, a program, a routine, sets of instructions, or a process, etc. for performing one or more functions.

The computer-readable recording media may include magnetic media such as a hard disk, a floppy disk, and a magnetic tape, optical media such as a Compact Disc-Read Only Memory (CD-ROM) and a Digital Versatile Disc (DVD), a Magneto-Optical Media such as a floptical disk, and a hardware device specially configured to store and perform a program instruction (e.g., the programming module) such as a Read Only Memory (ROM), a Random Access Memory (RAM), a flash memory, etc. Also, the program instruction may include not only a mechanical code such as a code made by a compiler but also a high-level language code executable by a computer using an interpreter, etc. The aforementioned hardware device may be constructed to operate as one or more software modules so as to perform operations in accordance with aspects of the disclosure.

A module or a programming module according to aspects of the disclosure may include at least one or more of the aforementioned constituent elements, or omit some of the aforementioned constituent elements, or further include additional other constituent elements. Operations carried out by the module, the programming module or the other constituent elements according to aspects of the disclosure may be executed in a sequential, parallel, repeated or heuristic method. Also, some operations may be executed in different order or may be omitted, or other operations may be added.

According to aspects of the disclosure, in a storage media storing instructions, the instructions are set to, when the instructions are executed by at least one processor, allow the at least one processor to perform at least one operation. The at least one operation may include operations of transmitting or receiving at least one signal among a first signal corresponding to a first communication network or a second signal corresponding to a second communication network in an electronic device and, if receiving at least one signal, distributing the at least one signal to each of a first communication control module for processing the first signal and a second communication control module for processing the second signal, based on that a service provided in the electronic device corresponds to the first signal and the second signal.

FIGS. 1-18 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the FIGS. may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. An apparatus comprising:
a communication interface; and
at least one processor configured to:
synchronize the apparatus with at least one electronic device;
receive, via the communication interface, a signal from the electronic device; and
determine a distance between the apparatus and the electronic device based on a transmission time and a reception time of the signal.

2. The apparatus of claim 1, wherein the processor is further configured to:
scan a discovery signal broadcasted from the electronic device every certain period;
receive the discovery signal from the electronic device;
form a group with the electronic device corresponding to the received discovery signal; and
perform the synchronization with the electronic device.

3. The apparatus of claim 2, wherein the received signal from the electronic device that is a member of the group comprises at least one of the transmission time, a position of the electronic device, availability of beamforming support in the electronic device, a transmission/reception beam index of the electronic device, and a distance between the electronic device and another electronic device that is also a member of the group.

4. The apparatus of claim 3, wherein the processor is further configured to determine a position of the electronic device based on a distance between the apparatus and the electronic device, and a distance between each of the electronic devices in the group.

5. The apparatus of claim 4, further comprising at least one sensor for sensing a movement of the apparatus, wherein the processor is configured to determine the position of the electronic device based on at least one of a movement direction and a movement distance changed by the movement of the apparatus.

6. The apparatus of claim 4, wherein the processor is further configured to:
determine a reference electronic device among the electronic device in the group;
acquire a position of the reference electronic device; and
determine the position of the electronic device, based on a positions of the apparatus and the reference electronic device, the distance between the apparatus and the electronic device, and the distance between each of the electronic devices in the group.

7. The apparatus of claim 6, wherein the processor is further configured to acquire the position of the reference electronic device based on a receive signal from the reference electronic device, or a changed distance between the apparatus and the reference electronic device by a movement of the apparatus.

8. The apparatus of claim 6, further comprising a camera and a display for displaying a screen for setting the position of the reference electronic device, wherein the processor is further configured to:
acquire a direction in which the reference electronic device is located, based on at least one of a movement direction of the apparatus, orientation of the apparatus, orientation of the camera, a touch direction, and a user input; and determine the position of the reference electronic device based on the acquired direction.

9. The apparatus of claim 8, wherein the processor is further configured to:
determine a transmission/reception beam index by performing beam training with the reference electronic device;
acquire a direction in which the reference electronic device is located, based on at least one of the orientation of the apparatus, the determined beam index; and
determine the position of the reference electronic device based on the acquired direction.

10. The apparatus of claim 1, wherein the processor is further configured to determine at least one of a transmission power of the apparatus, transmission data, and a function to be performed, based on the distance between the apparatus and the electronic device.

11. The apparatus of claim 1, further comprising at least one sensor for sensing a type of an available transmission medium, wherein the at least one processor is further configured to select a communications scheme for exchanging information with the electronic device based on the type of the transmission medium.

12. The apparatus of claim 1, wherein the processor is further configured to transmit the distance to other electronic devices connected with the apparatus, based on at least one of an operation mode of the apparatus, an amount of data to be displayed, and a battery level of the apparatus.

13. A method comprising:
synchronizing a apparatus with at least one electronic device;
receiving a signal from the electronic device; and
determining a distance between the apparatus and the electronic device based on a transmission time and a reception time of the signal.

14. The method of claim 13, further comprising:
scanning a discovery signal broadcasted from the electronic device every certain period;
receiving the discovery signal from the electronic device;
forming a group with the electronic device corresponding to the received discovery signal; and
performing the synchronization with the electronic device.

15. The method of claim 14, wherein the received signal from the electronic device that is a member of the group comprises at least one of the transmission time, a position of the electronic device, availability of beamforming support in the electronic device, a transmission/reception beam index of the electronic device, and a distance between the electronic device and another electronic device that is also a member of the group.

16. The method of claim 15, further comprising determining a position of the electronic device based on a distance between the apparatus and the electronic device, and a distance between each of the electronic devices in the group.

17. The method of claim 16, wherein the determining the position of the electronic device comprising:
sensing a movement of the apparatus;
determining the position of the electronic device based on at least one of a movement direction and a movement distance changed by the movement of the apparatus.

18. The method of claim 16, wherein the determining the position of the electronic device comprises:
determining a reference electronic device among the electronic device in the group;
acquiring a position of the reference electronic device; and
determining the position of the electronic device, based on a positions of the apparatus and the reference electronic device, the distance between the apparatus and the electronic device, and the distance between each of the electronic devices in the group.

19. The method of claim 13, further comprising:
sensing a type of an available transmission medium; and
selecting a communications scheme for exchanging information with the electronic device based on the type of the transmission medium.

20. The method of claim 13, further comprising transmitting the distance to other electronic devices connected with the apparatus, based on at least one of an operation mode of the apparatus, an amount of data to be displayed, and a battery level of the apparatus.
